(19) United States
(12) Patent Application Publication
(10) Pub. No.: US 2026/0300115 A1
(43) Pub. Date: Oct. 1, 2026

(54) BIG DATA CLUSTER DEPLOYMENT METHOD AND APPARATUS, DEVICE AND MEDIUM

(71) Applicants: Beijing BOE Technology Development Co., Ltd., Beijing (CN); BOE Technology Group Co., Ltd., Beijing (CN)

(72) Inventors: Rui GUAN, Beijing (CN); Ning ZHANG, Beijing (CN); Lin FAN, Beijing (CN); Wen HE, Beijing (CN)

(21) Appl. No.: 18/992,510

(22) PCT Filed: May 31, 2023
(86) PCT No.: PCT/CN2023/097480

§ 371 Date: Jan. 8, 2025

(30) Foreign Application Priority Data
Jul. 15, 2022 (WO) PCT/CN2022/106091

(51) Int. Cl. G06F 11/30; G06F 3/0486; G06F 11/32

(52) U.S. Cl. CPC G06F 11/3006; G06F 3/0486; G06F 11/327; G06F 11/328

(57) ABSTRACT

The present disclosure relates to a big data cluster deployment method and apparatus, a device and a medium. In the present disclosure, a data collecting service, a monitoring and alerting service, and a data visualizing and analyzing service are deployed for a big data cluster, such that the operational data of the big data cluster can be collected by the data collecting service, and the operational data can be uploaded to the data visualizing and analyzing service by the monitoring and alerting service. Therefore, the monitoring interface can be displayed according to the operational data by the data visualizing and analyzing service, to achieve monitoring of the operational status of the big data cluster and assist in the management of the big data cluster. Moreover, the entire service deployment process does not require manual user operation, greatly improving the service deployment efficiency of the big data cluster.

The present disclosure claims priority, with the prior application number PCT/CN2022/106091, titled “METHOD FOR DEPLOYING BIG DATA CLUSTER AND DATA PROCESSING METHOD BASED ON BIG DATA CLUSTER”, filed on Jul. 15, 2022, the entire contents of which are incorporated by reference into the present disclosure.

### TECHNICAL FIELD

The present disclosure relates to the field of computer technology, in particular to methods and apparatuses for deploying a big data cluster, devices and media.

### BACKGROUND

With rapid development of computer technology and information technology, the scale of an industry application system is rapidly expanding, and data generated by an industry application increases exponentially. With industries or enterprises with data scale of hundreds of terabyte (TB), dozens of petabyte (PB) or even hundreds of PB arising, to effectively process big data, research on big data management and application methods emerges as the times require.

In related technologies, generally, a big data cluster is deployed to run services in the big data cluster, to achieve high-speed data computation and storage. However, a big data cluster will include a plurality of servers, and each server can include a plurality of containers. Different containers can be used to provide big data cluster services for different service targets, which makes the management of the big data cluster particularly difficult. Therefore, there is an urgent need for a method to monitor the operation of various parts in the big data cluster, to assist in the management of the big data cluster.

### SUMMARY

The present disclosure provides methods and apparatuses for deploying a big data cluster, devices and media, to address deficiencies in related technologies.

According to the first aspect of the embodiments of the present disclosure, a method for deploying big data cluster is provided, and includes:
deploying a data collecting service, a monitoring and alerting service, and a data visualizing and analyzing service for the big data cluster;
collecting, by the data collecting service, operational data of the big data cluster, and uploading, by the monitoring and alerting service, the operational data to the data visualizing and analyzing service; and
displaying, by the data visualizing and analyzing service, a monitoring interface according to the operational data, where the monitoring interface is configured to display operational status of the big data cluster in a graphical manner.

According to the second aspect of the embodiments of the present disclosure, an apparatus for deploying a big data cluster is provided, and includes:
a deploying module, configured to deploy a data collecting service, a monitoring and alerting service, and a data visualizing and analyzing service for the big data cluster;
a data processing module, configured to collect, by the data collecting service, operational data of the big data cluster, and upload, by the monitoring and alerting service, the operational data to the data visualizing and analyzing service; and
a displaying module, configured to display, by the data visualizing and analyzing service, a monitoring interface according to the operational data, where the monitoring interface is configured to display operational status of the big data cluster in a graphical manner.

According to the third aspect of the embodiment of the present disclosure, a computing device is provided, which includes a memory, a processor, and a computer program stored in the memory and runnable on the processor, where the processor, when executing the program, achieves the method according to the first aspect.

According to the fourth aspect of the embodiment of the present disclosure, a computer-readable storage medium is provided, where the computer-readable storage medium stores a program, and the program when executed by a processor achieves the method according to the first aspect.

According to the above embodiments, in the present disclosure, a data collecting service, a monitoring and alerting service, and a data visualizing and analyzing service are deployed for a big data cluster, such that the operational data of the big data cluster can be collected by the data collecting service, and the operational data can be uploaded to the data visualizing and analyzing service by the monitoring and alerting service. Therefore, the monitoring interface can be displayed according to the operational data by the data visualizing and analyzing service, to achieve monitoring of the operational status of the big data cluster and assist in the management of the big data cluster. Moreover, the entire service deployment process does not require manual user operation, greatly improving the service deployment efficiency of the big data cluster.

It is to be understood that the above general descriptions and the below detailed descriptions are merely exemplary and explanatory, and are not intended to limit the present disclosure.

### BRIEF DESCRIPTION OF DRAWINGS

The accompanying drawings herein, which are incorporated in and constitute a part of the present description, illustrate examples consistent with the present disclosure and serve to explain the principles of the present disclosure together with the description.

FIG. 1 is a flowchart of a method for deploying a big data cluster according to embodiments of the present disclosure.

FIG. 2 is a schematic diagram of a deployment interface according to embodiments of the present disclosure.

FIG. 3 is a schematic diagram of a physical-layer monitoring interface according to embodiments of the present disclosure.

FIG. 4 is a schematic diagram of a physical-layer monitoring interface according to embodiments of the present disclosure.

FIG. 5 is a schematic diagram of a physical-layer monitoring interface according to embodiments of the present disclosure.

FIG. 6 is a schematic diagram of a physical-layer monitoring interface according to embodiments of the present disclosure.

FIG. 7 is a schematic diagram of an HDFS-component monitoring interface according to embodiments of the present disclosure.

FIG. 8 is a schematic diagram of a YARN-component monitoring interface according to embodiments of the present disclosure.

FIG. 9 is a schematic diagram of a Clickhouse-component monitoring interface according to embodiments of the present disclosure.

FIG. 10 is a schematic diagram of a component-layer monitoring interface according to embodiments of the present disclosure.

FIG. 11 is a flowchart of a deployment process of a physical-layer monitoring service according to embodiments of the present disclosure.

FIG. 12 is a flowchart of a deployment process of a component-layer monitoring service according to embodiments of the present disclosure.

FIG. 13 is a schematic diagram of a data flow of a monitoring service according to embodiments of the present disclosure.

FIG. 14 is a flowchart of a deployment process of a gateway proxy service according to embodiments of the present disclosure.

FIG. 15 is a schematic diagram of an information viewing interface according to embodiments of the present disclosure.

FIG. 16 is a flowchart of obtaining a container network address according to embodiments of the present disclosure.

FIG. 17 is a schematic diagram of a web interface for managing a HDFS component according to embodiments of the present disclosure.

FIG. 18 is a schematic diagram of a web interface for managing a YARN component according to embodiments of the present disclosure.

FIG. 19 is a schematic diagram of a client interface for managing a Hive component according to embodiments of the present disclosure.

FIG. 20 is a schematic diagram of a client interface for managing a Clickhouse component according to embodiments of the present disclosure.

FIG. 21 is a schematic diagram of an information viewing interface according to embodiments of the present disclosure.

FIG. 22 is a schematic diagram of a deployment interface according to embodiments of the present disclosure.

FIG. 23 is a schematic diagram of a deployment interface according to embodiments of the present disclosure.

FIG. 24 is a schematic diagram of a deployment interface according to embodiments of the present disclosure.

FIG. 25 is a schematic diagram of a deployment interface according to embodiments of the present disclosure.

FIG. 26 is a flowchart of a virtual-IP-address switching process according to embodiments of the present disclosure.

FIG. 27 is a flowchart of a virtual-IP-address switching process according to embodiments of the present disclosure.

FIG. 28 is a flowchart of a virtual-IP-address switching process according to embodiments of the present disclosure.

FIG. 29 is a schematic diagram of a virtual-IP-address switching result according to embodiments of the present disclosure.

FIG. 30 is a flowchart of a management-node migration process according to embodiments of the present disclosure.

FIG. 31 is a schematic structural diagram of a method for deploying a big data cluster according to embodiments of the present disclosure.

FIG. 32 is a block diagram of an apparatus for deploying a big data cluster according to embodiments of the present disclosure.

FIG. 33 is a schematic structural diagram of a computing device according to embodiments of the present disclosure.

### DETAILED DESCRIPTION

Embodiments will be described in detail herein, examples of which are illustrated in the accompanying drawings. Where the following description refers to the drawings, elements with the same numerals in different drawings refer to the same or similar elements unless otherwise indicated. Implementations described in the following embodiments do not represent all implementations consistent with the present disclosure. On the contrary, they are examples of an apparatus and a method consistent with some aspects of the present disclosure described in detail in the appended claims.

To facilitate understanding the present disclosure, technical terms involved in the present disclosure are introduced below.

Grafana: is an open-source analysis and visualization suite for the monitoring data, and can be used to create a monitoring dashboard to achieve visualization of the monitoring data. For example, Grafana can be used to visually analyze time-series data obtained by analyzing infrastructure and application data. In addition, Grafana can also be applied to other fields that require data visualization analysis. Grafana can assist in performing querying, visualizing, alerting, and analyzing on indicators and data. By providing a fast and flexible visualization effect, users can visualize data according to their needs.

Prometheus: is an open-source monitoring and alerting system according to a time-series database, is a leading monitoring solution, and is a one-stop monitoring and alerting platform, which has fewer dependencies, complete functions and high integration, and is convenient to be utilized. Grafana can connect to a Prometheus data source to display monitoring data in a graphical form. Prometheus can support data collection through various Exporters and also support data reporting through Pushgateway services. Prometheus has sufficient performance to provide monitoring and alarm functions for a cluster with tens of thousands devices, and is an open-source monitoring and alerting system according to a time-series database.

Exporter: is a general term for a type of data collection component of Prometheus, and is mainly used for collecting data. Moreover, in addition to collecting data from a target, Exporters can also convert the collected data into a format supported by Prometheus. Unlike traditional data collection components, Exporter does not transmit data to the Central Processing Unit (CPU), but waits for the CPU to actively crawl data. Exporter is the object monitored by Prometheus. An interface of the Exporter can be exposed to Prometheus service in the form of Hyper Text Transfer Protocol (HTTP) service. Prometheus service can obtain the monitoring data to be collected by accessing the interface provided by the Exporter. There are many common Exporters, such as Node Exporter, Mysqld Exporter, Haproxy Exporter, etc., which support service monitoring of service providers such as HAProxy, StatsD, Graphite, Redis, etc.

Node Exporter: is used to collect server-level running indicators, such as system average load (Loadavg), file system (Filesystem), memory management (Meminfo), and other basic monitoring of machines. In addition, Node Exporter can also be used to monitor the usage of components such as CPU, memory, disks, and I/O in container servers. If you want to collect data through Node Exporter, you first need to deploy Node Exporter on the service that needs to collect data, to collect data through the deployed Node Exporter.

Apache Knox: The main goal of an Apache Knox project is to provide access to Apache Hadoop through an HTTP resource proxy. The Apache Knox gateway can extend the coverage of an Apache Hadoop service to users outside a Hadoop cluster without reducing Hadoop security.

Knox gateway can provide security for multiple Hadoop clusters and has the following advantages.

(1) Simplified access: by encapsulating Kerberos (a computer network authorization protocol used to securely authenticate personal communication in a non-secure network) into a cluster, the service providing scopes of Hadoop's Representational State Transfer (REST) service and the HTTP service are extended.

(2) Improved security: Hadoop's REST and HTTP services are exposed without revealing network details, and an out-of-the-box use is provided through the Secure Socket Layer (SSL) protocol.

(3) Centralized control: the security of centralizedly executing the REST service API (Application Programming Interface) is ensured and requests are routed to multiple Hadoop clusters.

(4) Enterprise Integration: various types of authentication systems are supported, such as Lightweight Directory Access Protocol (LDAP), Active Directory (AD), Single Sign On (SSO), and Security Assertion Markup Language (SAML).

A method for deploying a big data cluster provided in the present disclosure is described in detail below.

The present disclosure provides a method for deploying a big data cluster, which is used to automatically deploy corresponding monitoring services (including data collecting services, monitoring and alerting services, and data visualizing and analyzing services) for deployed servers and containers after completing the deployment of servers and containers in a big data cluster by dragging and dropping nodes. The deployed monitoring services are used to monitor the operation of the big data cluster, and the monitoring results can be visualized to assist in the operation and maintenance of the big data cluster, which reduces the technical threshold for operation and maintenance of the big data cluster. Moreover, through the solution provided in the present disclosure, automated deployment of monitoring services can be achieved, which improves the efficiency of service deployment in the big data cluster.

The above is only an exemplary introduction to the application scenarios of the present disclosure and does not constitute any limitation of the application scenario of the present disclosure. In some embodiments, the method for deploying big data cluster provided in the present disclosure can also be used to deploy monitoring services in other service clusters, which is not limited in the present disclosure.

The above method for deploying big data cluster can be executed by a computing device, such as one server, multiple servers, or a server cluster, etc. The present disclosure does not limit the type and the number of computing devices.

For ease of understanding, the process of deploying servers and containers in a big data cluster by dragging and dropping nodes is first explained.

In some embodiments, relevant technical personnel can build a basic network environment required to build a big data cluster on any service according to actual technical requirements. The server with the basic network environment deployed can act as a management server, and subsequent deployment of servers and/or containers can be carried out on the basis of the management server, to achieve the deployment of the big data cluster.

In some embodiments, the relevant technical personnel can add servers to the big data cluster according to actual needs to build a big data cluster that includes multiple servers.

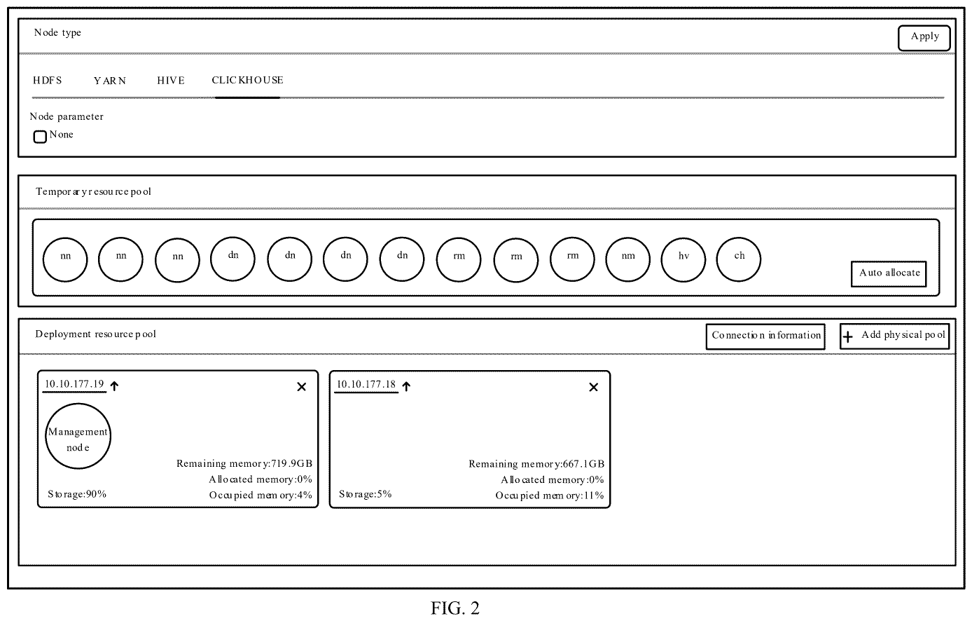

In some embodiments, a deployment interface can be provided, to provide deployment functions of the big data cluster through the deployment interface. In some embodiments, a control for adding physical pool can be set in the deployment interface to add a server to the big data cluster. For example, a region for adding physical pool can be set in the deployment interface, to set the control for adding physical pool in the deployment resource pool region. Referring to FIG. 2, a schematic diagram of a deployment interface according to embodiments of the present disclosure, the deployment interface is divided into a region for node creation, a region for the temporary resource pool, and a region for the deployment resource pool. The “Add Physical Pool” button set in the deployment resource pool region is the control for adding a new physical pool. By clicking the “Add Physical Pool” button, the server can be added to the big data cluster.

By setting the add-new-physical-pool control in the deployment interface, users can add servers to the big data cluster according to actual technical needs, such that the created big data cluster can meet technical requirements and ensure the smooth progress of subsequent data processing processes.

In some embodiments, adding a physical pool to add a server to the big data cluster can be achieved through the following steps.

In step 1, in response to the triggering operation for the add-new-physical-pool control, an interface for adding a physical pool is displayed. The interface for adding a physical pool includes an identifier obtaining control and a password obtaining control.

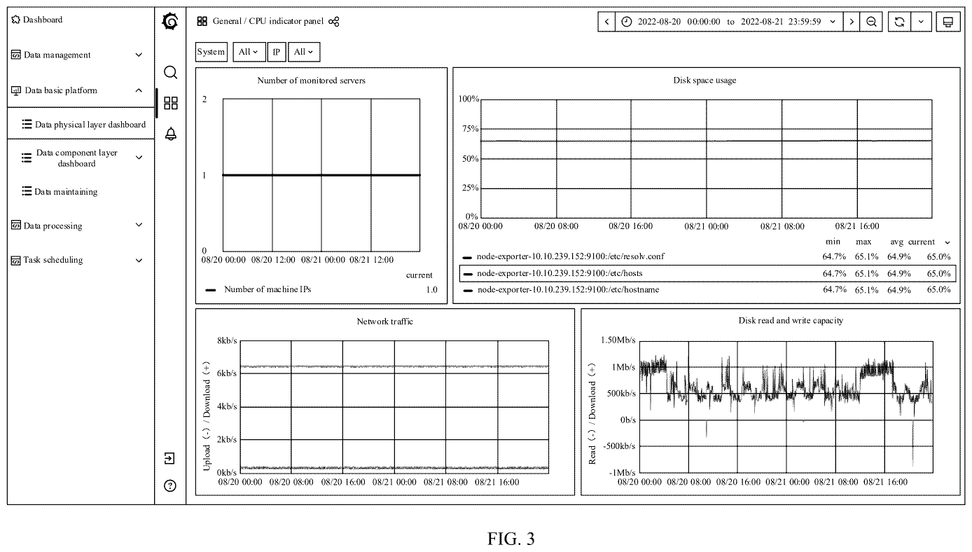

Referring to FIG. 3, which is a schematic diagram of an interface for adding a physical pool according to embodiments of the present disclosure, after the add-new-physical-pool control is triggered, the interface for adding a physical pool as shown in FIG. 3 can be displayed on a visualized interface, where an input box with a text prompt of “IP” is the identification acquisition control, and an input box with a text prompt of “password” is the password obtaining control.

In step 2, through the identifier obtaining control, the server identifier corresponding to the to-be-added physical pool is obtained, and through the password obtaining control, the to-be-verified password is obtained.

In some embodiments, the relevant technical personnel can enter the server identifier of the server to be added into the big data cluster in the identifier obtaining control, and enter a preset password in the password obtaining control, such that the computing device can obtain the server identifier corresponding to the to-be-added physical pool through the identifier obtaining control, and obtain the to-be-verified password through the password obtaining control.

In some embodiments, after the server identifier corresponding to the to-be-added physical pool is obtained through the identifier obtaining control, and the to-be-verified password is obtained through the password obtaining control, the to-be-verified password can be verified.

In step 3, if the to-be-verified password is successfully verified, the to-be-added physical pool is displayed in the deployment resource pool region.

By setting the identifier obtaining control, a user can enter the server identifier of the server to be added to the big data cluster in the identifier obtaining control to meet customization needs. By setting the password obtaining control, a user can enter the to-be-verified password in the password acquisition interface to verify the identity of the user according to the to-be-verified password, to determine whether the user has the authority to participate in the process of adding servers to the big data cluster, in order to ensure the security of the deployment process of the big data cluster.

Once the to-be-verified password is successfully verified, the server corresponding to the obtained server identifier can be added to the big data cluster.

Through the above process, the hardware environment of the big data cluster can be constructed to obtain a big data cluster that includes at least one server, such that containerization deployment is performed on the at least one server, such that the big data cluster can provide users with big data processing functions.

In some embodiments, the deployment interface includes a region for node creation. The node creation region includes a control for node creation and at least one big data component. The big data components at least include a Hadoop Distributed Filed System (HDFS) component, a Yet Another Resource Negotiator (YARN) component, a Clickhouse component, or a Hive component.

The HDFS component can be configured to provide data storage functionality. In other words, to provide data storage functionality for users, a container corresponding to the node of the HDFS component needs to be deployed in the big data cluster to provide distributed data storage services for users through the deployed container to meet user needs.

The YARN component can be configured to provide data analysis functionality, which means that if data analysis functionality needs to be provided to users, a container corresponding to the node of the YARN component needs to be deployed in the big data cluster, to obtain data from the container corresponding to the node of the HDFS component through the container corresponding to the node of the YARN component, and perform data analysis according to the obtained data, to meet data analysis needs.

The Hive component can convert the data stored in the container corresponding to the node of the HDFS component into a queryable data table, such that data query and processing can be carried out according to the data table to meet the data processing needs.

It should be noted that although both the YARN component and the Hive component can provide data analysis functionality for users, the difference is that if the YARN component is used to implement the data analysis process, a series of codes need to be developed to perform the corresponding data processing process according to the data processing task after submitting the data processing task to the YARN component. However, if the Hive component is used to implement the data analysis process, Structured Query Language (SQL) statements can be used to process the data processing task.

The Clickhouse component is a columnar storage database that can be configured to meet storage needs of users for a large amount of data. Compared to commonly used row storage databases, the Clickhouse component has a faster reading speed, and the Clickhouse component can store data in different partitions, and users can only obtain data in one or several partitions for processing according to actual needs, without obtaining all the data in the database, thereby reducing the data processing pressure of computing devices.

In some embodiments, at least one big data component can be displayed on the deployment interface so that users can choose from the at least one big data component displayed on the deployment interface according to actual technical requirements. When any one big data component is selected, in response to the triggering operation on the node creating control, a to-be-deployed node corresponding to the selected big data component is displayed in the temporary resource pool region.

It should be noted that different components contain different nodes. In some embodiments, The HDFS component includes a node of NameNode (nn), a node of DataNode (dn) and a node of SecondaryNameNode (sn). The YARN component includes a node of ResourceManager (rm) and a node of NodeManager (nm). The Hive component includes a node of Hive (hv). The Clickhouse component includes a node of Clickhouse (ch).

According to the relationship between the above components and nodes, the computing device can display the corresponding node in the temporary resource pool region as to-be-deployed node according to the selected big data component. Users can drag and drop the to-be-deployed node from the temporary resource pool region to the physical pool in the deployment resource pool region, such that container deployment can be achieved in the big data cluster through drag and drop operations on the node.

In some embodiments, in response to a drag and drop operation on the to-be-deployed node in the temporary resource pool region, the to-be-deployed node is displayed in a physical pool in the deployment resource pool region in the deployment interface.

The deployment resource pool region can include at least one physical pool. In some embodiments, when in response to the drag and drop operation on the to-be-deployed nodes in the temporary resource pool region, displaying the to-be-deployed nodes in the physical pool in the deployment resource pool region of the deployment interface, for any one to-be-deployed node, in response to the drag and drop operation on the to-be-deployed node, the to-be-deployed node can be displayed in the physical pool indicated at the end of the drag and drop operation.

By providing drag-and-drop functionality for the nodes displayed in the deployment interface, users can drag and drop each to-be-deployed node to the corresponding physical pool according to actual technical needs to meet customized needs of the users.

It should be noted that after all the to-be-deployed nodes in the temporary resource pool region are dragged and dropped to the deployment resource pool region, in response to a start deployment operation in the deployment interface, the containers corresponding to the to-be-deployed nodes can be deployed on the server corresponding to the physical pool according to the physical pool where the to-be-deployed nodes are located.

The above embodiments mainly introduce the process of adding physical pools and deploying containers corresponding to nodes in the physical pool. In some embodiments, the deployment resource pool region can further be provided with a delete-physical-pool control.

When the deployment resource pool region includes the delete-physical-pool control, the relevant technical personnel can delete the physical pool through the delete-physical-pool control.

In some embodiments, one physical pool corresponds to one delete-physical-pool control, and the relevant technical personnel can trigger a delete-physical-pool control corresponding to any one physical pool. The computing device can respond to the trigger operation on any one deleting physical pool control and no longer display the physical pool corresponding to the triggered delete-physical-pool control in the deployment resource pool region.

Taking the deployment interface shown in FIG. 2 as an example, each physical pool displayed in the deployment resource pool region of the deployment interface has a “x” button, which is configured as the delete-physical-pool control. Users can trigger any one “x” button to delete the corresponding physical pool.

By setting the delete-physical-pool control in the deployment interface, users can delete any one physical pool according to actual needs, to remove the server corresponding to the physical pool from the big data cluster, which can meet their technical needs. Moreover, the operation is simple, and users only need a simple operation of triggering the control to complete the modification of the big data cluster, greatly improving operational efficiency.

It should be noted that when a service is removed from the big data cluster, the containers deployed on the server will also be removed from the big data cluster.

After the basic deployment process of the big data platform is introduced, a method for deploying a big data cluster provided in the present disclosure is described in detail below.

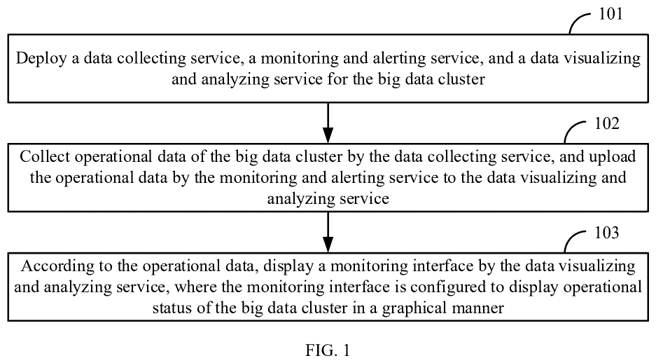

Referring to FIG. 1, it is a flowchart of a method for deploying big data cluster according to embodiments of the present disclosure. As shown in FIG. 1, the method includes steps 101-103.

In step 101, a data collecting service, a monitoring and alerting service, and a data visualizing and analyzing service are deployed for the big data cluster.

A big data cluster can include multiple servers, and each server can be deployed with at least one container, to provide big data services through the deployed container. The container deployed in the big data cluster is created according to a drag and drop operation on a node in the deployment interface. The deployment interface is configured to provide deployment functions for the big data cluster, including but not limited to deploying servers in the big data cluster and deploying containers on servers.

In some embodiments, a container deployed on a server may include a container corresponding to a Hadoop Distributed File System (HDFS) component, a container corresponding to a Yes Another Resource Negotiator (YARN) component, a container corresponding to a database tool (Clickhouse) component, a container corresponding to a data warehouse tool (Hive) component, etc. The present disclosure does not limit the specific types of deployed containers.

Referring to FIG. 2, FIG. 2 is a schematic diagram of a deployment interface according to embodiments of the present disclosure. As shown in FIG. 2, the deployment interface can provide an HDFS component, a YARN component, a Hive component, and a Clickhouse component. Users can select the corresponding component to deploy the container corresponding to the selected component in a big dataset cluster. It should be noted that different types of components can correspond to different nodes. For example, the HDFS component includes NameNode (nn) node, DataNode (dn) node, and SecondaryNameNode (sn) node, the YARN component includes ResourceManager (rm) node and NodeManager (nm) node, the Hive component includes Hive (hv) node, and the Clickhouse component includes Clickhouse (ch) node. After users select a component, the nodes included in this component will be displayed in the temporary resource pool region of the deployment interface. Users can modify (including adding nodes, or deleting nodes, etc.) the to-be-deployed node in the temporary resource pool region (including adding or deleting nodes), etc.). Users can drag and drop nodes from the temporary resource pool to various physical pools in the deployment resource pool (one physical pool corresponds to one server in a big data cluster), to deploy containers corresponding to the nodes included in the physical pool on the corresponding servers, achieving the goal of containerized deployment of the big data cluster through drag and drop operations.

After the containerized deployment of the big data cluster is completed through the deployment interface, the deployed big data cluster can provide users with the basic data processing functions of the big data processing platform. For example, the deployed big data cluster can be provided to users in the form of a big data processing platform. Users can set calculation tasks in the big data processing platform, such as setting data required to execute the calculation tasks and calculation instructing information (such as calculation rules) according to which the calculation tasks are executed, such that the corresponding data can be obtained through the generally deployed big data cluster and corresponding processing can be performed according to the obtained data, to obtain processing results that meet user needs.

In addition to deploying a basic big data cluster for providing basic data processing functions, a data collecting service, a monitoring and alerting service, and a data visualizing and analyzing service can further be deployed for the big data cluster, which enables monitoring of the operation of the big data cluster through the deployed data collecting service, monitoring and alerting service, and data visualizing and analyzing service, providing strong assistance for the operation and maintenance of the big data cluster.

The data collecting service is configured to collect the operational data of the service provider(s) in the big data cluster, the monitoring and alerting service is configured to transfer data between the data collecting service and the data visualizing and analyzing service, and the data visualizing and analyzing service is configured to graphically display the reported operational data.

It should be noted that the data collecting service can not only collect operational data from service providers in the big data cluster, but also collect production data generated by users during an actual production process, and storage data stored on local servers or containers, including but not limited to various types of data of production data, multimedia data, tensor data, structured data, etc. For example, in a production line scenario in a production park, the data collecting service can be used to collect production data generated by various processes, stations, raw materials, algorithms, etc. on the production line. In a commercial/cultural tourism scenario of a living park, the data collecting service can be used to collect multimedia data, tensor data, structured data, etc. generated according to services such as passenger flow statistics, humanoid recognition, hotspot tracking, and restricted area statistics. The multimedia data can be video frame data collected by a camera deployed in the park, the tensor data can be vectorized data generated according to facial recognition, and the structured data can be various types of data used for big data calculation and analysis. The present disclosure does not limit specific data types.

In some embodiments, the provision of the data collecting service can be achieved by deploying an Exporter service (i.e., deploying an Exporter component) in the big data cluster, the monitoring and alerting services can be achieved by deploying a Prometheus service (i.e., deploying a Prometheus system) in the big data cluster, and the data visualizing and analyzing service can be achieved by deploying a Grafana service (i.e., deploying a Grafana plugin) in the big data cluster.

In step 102, operational data of the big data cluster is collected by the data collecting service, and the operational data is uploaded by the monitoring and alerting service to the data visualizing and analyzing service.

In step 103, according to the operational data, a monitoring interface is displayed by the data visualizing and analyzing service, where the monitoring interface is configured to display operational status of the big data cluster in a graphical manner.

In the present disclosure, a data collecting service, a monitoring and alerting service, and a data visualizing and analyzing service are deployed for a big data cluster, such that the operational data of the big data cluster can be collected by the data collecting service, and the operational data can be uploaded to the data visualizing and analyzing service by the monitoring and alerting service. Therefore, the monitoring interface can be displayed according to the operational data by the data visualizing and analyzing service, to achieve monitoring of the operational status of the big data cluster and assist in the management of the big data cluster. Moreover, the entire service deployment process does not require manual user operation, greatly improving the service deployment efficiency of the big data cluster.

After the basic implementation process of the method for deploying big data cluster provided in the present disclosure is introduced, various embodiments of the present disclosure are introduced below.

It should be noted that the monitoring and alerting service and the data visualizing and analyzing service can be used as a universal underlying service, and can be deployed once to provide corresponding services for the entire big data cluster. Therefore, deploying the Prometheus and Grafana services in the big data cluster once can provide the monitoring and alerting service and the data visualizing and analyzing service for the entire big data cluster through the deployed Prometheus and Grafana services.

For different types of service objects, the specific types of data collecting services required may be different. In some embodiments, the data collecting service can include the first data collecting service and the second data collecting service. The first data collecting service can be used to collect operational data of a server, and the second data collecting service can be used to collect operational data of a container. Therefore, the first data collecting service can also be called the physical-layer data collecting service, and the second data collecting service can also be called the component-layer data collecting service.

When the data collecting service is to be deployed, for each of service objects, the Exporter component that match the type of the service object can be deployed for the service object. If the service object is a server, an Exporter component corresponding to the first data collecting service can be deployed for the service, for example, the Node Exporter component can be deployed for the server. If the service object is a container, an Exporter component corresponding to the second data collecting service can be deployed for the container. However, it should be noted that different types of containers correspond to different types of Exporter components. For example, the Exporter component used to provide the data collecting services for the containers corresponding to the HDFS component and the YARN component can be a Hadoop Exporter, and the Exporter component used to provide the data collecting service for the Clickhouse component can be a Clickhouse Exporter.

It should be noted that for the first data collecting service used to collect operational data of a server, a corresponding first data collecting service needs to be deployed on each server, where the corresponding first data collecting service is specifically used for collecting operational data of the corresponding server. For the second data collecting service used to collect operational data of a container, for each type of container, the data collecting service corresponding to this type of container is only deployed once on a server in the big data cluster, and the operational data of this type of containers in the entire big data cluster can be collected through the deployed second data collecting service. For example, if the big data cluster includes three servers, each server has a container corresponding to an HDFS component, the Hadoop Exporter service (i.e., the Hadoop Exporter component) can be deployed on one of the servers, and operational data of the containers corresponding to the HDFS component on these three servers can be collected through the deployed Hadoop Exporter service.

After a preliminary introduction to the data collecting service, the monitoring and alerting service, and the data visualizing and analyzing service, the following is a detailed process of deploying the data collecting service, the monitoring and alerting service, and the data visualizing and analyzing service in a big data cluster.

In some embodiments, for step 101, deploying the data collecting service, the monitoring and alerting service, and the data visualizing and analyzing service for the big data cluster can be implemented by following steps 1011-1012.

In step 1011, according to a deployed service provider in the big data cluster, the data collecting service, the monitoring and alerting service, and the data visualizing and analyzing service are deployed for the deployed service provider in the big data cluster.

It should be noted that for the multiple servers included in the big data cluster, there can be a management server among these servers. After the management server is deployed, the foundation of the big data cluster platform is established, which means that the big data basic service platform has been built, and various services can be further deployed on the foundation of the big data basic service platform. The management server can act (or serve) as a core device for providing a big data cluster service. Therefore, for step 1011, deploying the data collecting service, the monitoring and alerting service, and the data visualizing and analyzing service for the big data cluster can be implemented by:

according to servers and containers in the big data cluster, deploying the data collecting service on each of the servers of the big data cluster, and deploying the monitoring and alerting service and the data visualizing and analyzing service on the management server of the big data cluster.

In some embodiments, when the monitoring and alerting service and the data visualizing and analyzing service are deployed on the management server of the big data cluster, the Prometheus service can be deployed on the management server of the big data cluster to achieve the deployment of the monitoring and alerting service on the management server; and the Grafana service can be deployed on the management server of the big data cluster to achieve the deployment of data visualizing and analyzing service on the management server.

When the data collecting service is to be deployed on each server in the big data cluster, the first data collecting service and the second data collecting service can be deployed for the management server, and the first data collecting service can be deployed for each of the servers except the management server. The first data collecting service and the second data collecting service are deployed simultaneously on the management server. The deployed first data collecting service is used to collect operational data of the management server, and the deployed second data collecting service is used to provide the data collecting service for various containers in the big data cluster.

In some embodiments, for servers in a big data cluster, operational data can include disk space usage data, network traffic data, CPU usage data, memory usage data, etc. For containers in a big data cluster, operational data can include big data service usage data and container status data, etc. The present disclosure does not limit the specific types of operational data.

In some embodiments, when the first data collecting service is to be deployed on the management server, the Node-Exporter service can be deployed on the management server to collect operational data of the management server through the deployed Node-Exporter service. When the second data collecting service is to be deployed on the management server, the Hadoop Exporter service can be deployed on the management server to collect the operational data of the containers corresponding to the HDFS component and the YARN component in the big data cluster through the deployed Hadoop Exporter service. Further, the Clickhouse Exporter service can be deployed on the management server to collect operational data of the container corresponding to the Clickhouse component in the big data cluster through the deployed Clickhouse Exporter service.

It should be noted that in order to ensure the smooth operation of the deployed monitoring service (including the monitoring and alerting service, the data visualizing and analyzing service, and the data collecting service), the deployed services can be debugged after deployment, to ensure that the deployed services can be used normally.

In addition, a Prometheus data source can be pre-configured in the Grafana service to ensure communication between the deployed Grafana service and Prometheus service, such that the Prometheus service can transmit crawled data to the Grafana service after crawling data from various Exporter services.

In addition, the Grafana service can provide various available page templates, and relevant technical personnel can download the page templates they need according to actual technical needs, to create monitoring pages that meet actual technical requirements according to the downloaded page templates, and import the produced monitoring pages into the Grafana service. For example, the URL address of the produced monitoring page can be imported into the Grafana service to achieve the import of the produced monitoring page. In addition, an image file can be generated for the Grafana service into which the monitoring page has been imported. Subsequently, the Grafana service can be initiated by running the image file. As the URL address of the made monitoring page has been imported into the Grafana service, the monitoring page can be displayed according to the imported URL address.

In step 1012, in response to an update operation on the deployed service provider in the big data cluster, a deployed data collecting service, a deployed monitoring and alerting service, and a deployed data visualizing and analyzing service are updated in the big data cluster, where the update operation on the deployed service provider includes deleting the deployed service provider and deploying a new service provider.

It should be noted that the monitoring and alerting service corresponds to a first configuration file. The first configuration file can record which data collecting services the data to be transmitted to the data visualizing and analyzing service comes from. Since the update operation can include deleting a deployed service provider and deploying a new service provider, the following will introduce the service deployment process corresponding to two update operations.

In the case where the update operation on the deployed service provider is to deploy a new service provider, step 1012 can be implemented by:
in some embodiments, in response to addition of a new server in the big data cluster, deploying the first data collecting service on the new server, and modifying the first configuration file corresponding to the monitoring and alerting service according to a new service provider, to enable the deployed monitoring and alerting service and the deployed data visualizing and analyzing service in the big data cluster to provide services for the new server.

In some embodiments, in order to distinguish the first data collecting services deployed on the management server and the new server, the first data collecting services deployed on the management server and the newly added server can be named separately to achieve the distinction between the two through naming. For example, the naming rule of Node-Exporter-ip can be used to distinguish different first data collecting services through the IP field in the named service name.

In addition, it should be noted that the monitoring and alerting service can correspond to a first configuration file. For example, the Prometheus service can maintain a first configuration file. The first configuration file can be configured to indicate the service configuration information of the data collecting service corresponding to the data to be transmitted to the data visualizing and analyzing service. Therefore, after the first data collecting service is deployed on the new server, the first configuration file maintained by the Prometheus service can be modified to update the first configuration file maintained by Prometheus, to ensure that the updated first configuration file includes the service configuration information of the newly deployed first data collecting service, to indicate that the operational data collected by the newly deployed first data collecting service also needs to be transmitted to the data visualizing and analyzing service.

The service configuration information of the first data collecting service can include various information such as a service name, a server to which the service belongs, etc, which is not limited in the present disclosure.

In some embodiments, in response to addition of a new container in the big data cluster, the first configuration file corresponding to the monitoring and alerting service is modified according to a new server, to enable the deployed second data collecting service, the deployed monitoring and alerting service, and the deployed data visualizing and analyzing service in the big data cluster to provide services for the new container.

It should be noted that as mentioned in the above embodiments, for the containers corresponding to the same type of components on different servers, the second data collecting service is deployed one-time to collect the operational data of the containers. The first configuration file maintained by the Prometheus service can also record the service configuration information of the second data collecting service. In some embodiments, the service configuration information of the second data collecting service can include various information such as container information (such as container name, container type) of the container on which the second data collecting service acts, which is not limited in the present disclosure.

Therefore, when a new container is added in the big data cluster, the second data collecting service deployed on the management server can be directly updated according to the container information of the new container, such that the second data collecting service deployed on the management server can provide a data collecting service for the new container, which is equivalent to achieving the deployment of the second data collecting service on the new container without the need to deploy the second data collecting service again.

The above embodiments are illustrated by deploying a second data collecting service on a management server. In some embodiments, a server can be randomly selected from the servers included in the big data cluster to deploy the second data collecting service on that server. It should be noted that different types of second data collecting services can be deployed on different servers, but for the same type of second data collecting service, the second data collecting service only needs to be deployed once on one server. However, regardless of which server the second data collecting service is deployed on, the first configuration file maintained by the monitoring and alerting service deployed on the management server needs to be updated.

It should be noted that due to the difference in nature between the physical layer and the component layer, physical-layer monitoring can be deployed when the basic service platform is deployed, but component-layer monitoring needs to wait until the big data component is truly deployed before component-layer monitoring can be deployed. That is, the process of deploying the first data collecting service for the new server can be carried out simultaneously with the process of deploying the new server, and the process of deploying the second data collecting service for the new container can be carried out after the deployment of the new container is completed.

Therefore, a status querying interface can be provided to query the current deployment status of a component in the big data cluster. If a container corresponding to a big data component has been deployed, the URL address of a pre-generated image file for the container corresponding to the big data component can be returned, and otherwise, a null value can be returned, such that it is determined whether the current component has been deployed according to the return value.

In other embodiments, in the case where the update operation on the deployed service provider is to delete a deployed service provider, step 1012 can be implemented by the following embodiments.

The above embodiments mainly introduce the method for service deployment when adding a new service provider. In some embodiments, deployed servers and/or containers in the big data cluster can also be deleted.

In some embodiments, in response to deletion of a deployed server in the big data cluster, the first data collecting service corresponding to a deleted server is deleted, and the first configuration file corresponding to the monitoring and alerting service is modified according to the deleted server, to enable the deployed monitoring and alerting service deployed data visualizing and analyzing service in the big data cluster no longer to provide services for the deleted server.

In some embodiments, in response to a deletion of a server in the big data cluster, the first data collecting service deployed for the server is deleted, and the first configuration file maintained by the monitoring and alerting service can be modified to remove the service configuration information of the first data collecting service corresponding to the server from the first configuration file, such that when data collected by the deployed data collecting service is obtained according to the updated first configuration file, data is not obtained from the deleted server.

In some embodiments, in response to deletion of a deployed container in the big data cluster, the first configuration file corresponding to the monitoring and alerting service is modified according to a deleted server, to enable the deployed second data collecting service, the deployed monitoring and alerting service, and the deployed data visualizing and analyzing service in the big data cluster no longer to provide services for the deleted server.

In some embodiments, in response to deletion of a container in the big data cluster, the first configuration file maintained by the monitoring and alerting service is modified to delete the service configuration information of the second data collecting service corresponding to the container from the first configuration file, such that when data collected by the deployed data collecting service is obtained, the data is not obtained from the deleted container.

In some embodiments, different function interfaces can be provided to implement deployment processes for different types of services. For example, a physical-pool-initializing interface can be provided for deploying the first data collecting service for a newly added server. A physical-pool-deleting interface can be provided for deleting the first data collecting service corresponding to a server when the server is deleted. A deployment interface can further be provided for deploying a second data collecting service for a newly added container, and/or for deleting the second data collecting service corresponding to a container when the container is deleted.

It should be noted that in order to automatically deploy data collecting services, monitoring and alerting services, and data visualizing and analyzing services at any one node, and ensure that the data collecting services, monitoring and alerting services, and data visualizing and analyzing services can recognize each other and exchange data with each other, it is necessary to deploy the data collecting services, monitoring and alerting services, and data visualizing and analyzing services in the same Overlay network. That is, the Prometheus server, the Grafana service, and all Exporters need to be set up in the same Overlay network.

After setting the Prometheus server, the Grafana service, and all Exporters in the same Overlay network, a deployed service can be named according to a pre-set naming rule when a container is started, such that the named service can be recorded in the first configuration file, such that the Prometheus service can crawl data according to the first configuration file.

For example, when a Node-exporter is deployed, the Node-exporter service deployed on each machine can be named according to the naming rule of node-exporter-server name (such as ip1, ip2, . . . ), and the naming result can be recorded in the first configuration file of the Prometheus service. The Prometheus service can then obtain the data of each Exporter. For services like Prometheus and Gafana that only require deployment once, the Prometheus and Gafana can be simply named as Prometheus and Grafana. When a data source is configured in Grafana, it only needs to configure “http://prometheus:9090”, such that the Grafana service can read the data from the Prometheus service.

The Overlay network can virtualize the network connections between multiple hosts and run applications within this virtual network to achieve the effect of isolating applications from the underlying network. By deploying data collecting services, monitoring and alerting services, and data visualizing and analyzing services in the Overlay network, a natural protection mechanism can be formed to provide additional security protection for the big data cluster and enhance the security of the big data cluster.

After the deployment of data collecting service, monitoring and alerting service, and data visualizing and analyzing service is completed through the above embodiments, through step 102, operational data of the big data cluster is collected by the data collecting service, and the operational data is uploaded by the monitoring and alerting service to the data visualizing and analyzing service.

In some embodiments, the operational data of the server can be collected through the deployed first data collecting service, and the operational data of the container can be collected through the deployed second data collecting service. The data collected by the first data collecting service and second data collecting service can be transmitted to the data visualizing and analyzing service through the monitoring and alerting service, such that the data visualizing and analyzing service can display the monitoring interface according to the operational data through step 103.

In some embodiments, for step 103, displaying the monitoring interface according to operational data can be achieved through the following embodiments.

In some embodiments, according to the operational data of servers in the big data cluster, a physical-layer monitoring interface is displayed, which is used to display the operational data of the servers in the big data cluster. In some embodiments, the physical-layer monitoring interface can also be referred to as the physical-layer dashboard.

Referring to FIG. 3, FIG. 3 is a schematic diagram of a physical-layer monitoring interface according to embodiments of the present disclosure. In the case where only the management server is deployed in a big data cluster, the monitoring interface shown in FIG. 3 can be displayed. As shown in FIG. 3, when only the management server is included in the big data cluster, the number of monitored servers is displayed as 1, and the disk space usage data (i.e., disk space usage rate and disk read and write capacity) and network traffic data (i.e., network traffic) of the management server can be displayed in the physical-layer monitoring interface shown in FIG. 3.

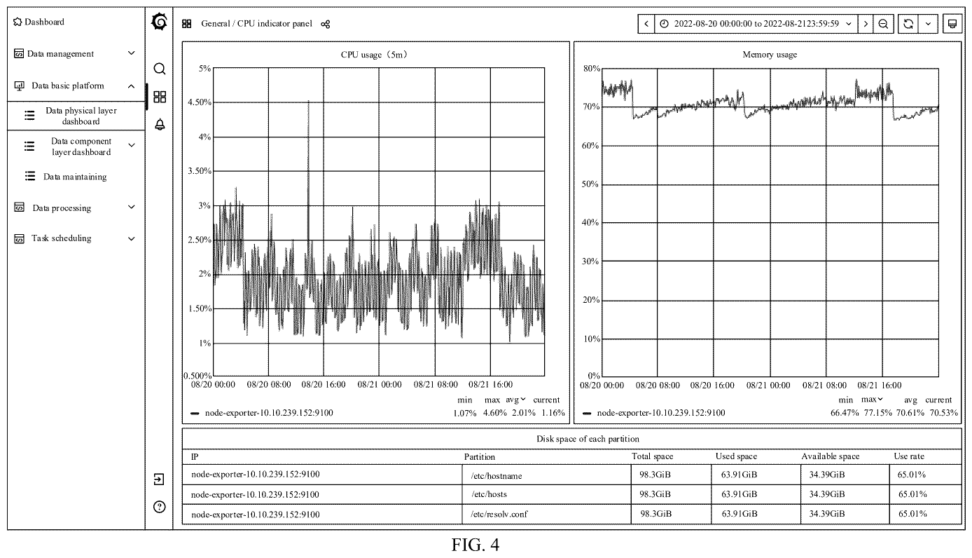

In addition, a functional control for flipping pages can be set in the physical-layer monitoring interface shown in FIG. 3, through the functional control users can view more types of operational data. If the user triggers the functional control in the physical-layer monitoring interface shown in FIG. 3, the computing device can display the physical-layer monitoring interface shown in FIG. 4. FIG. 4 is a schematic diagram of another physical-layer monitoring interface shown according to the embodiment of the present disclosure. In the physical-layer monitoring interface shown in FIG. 4, CPU usage data (i.e., CPU usage rate), memory usage data (i.e., memory usage rate), and disk space usage data (i.e., the disk space of each partition) are displayed

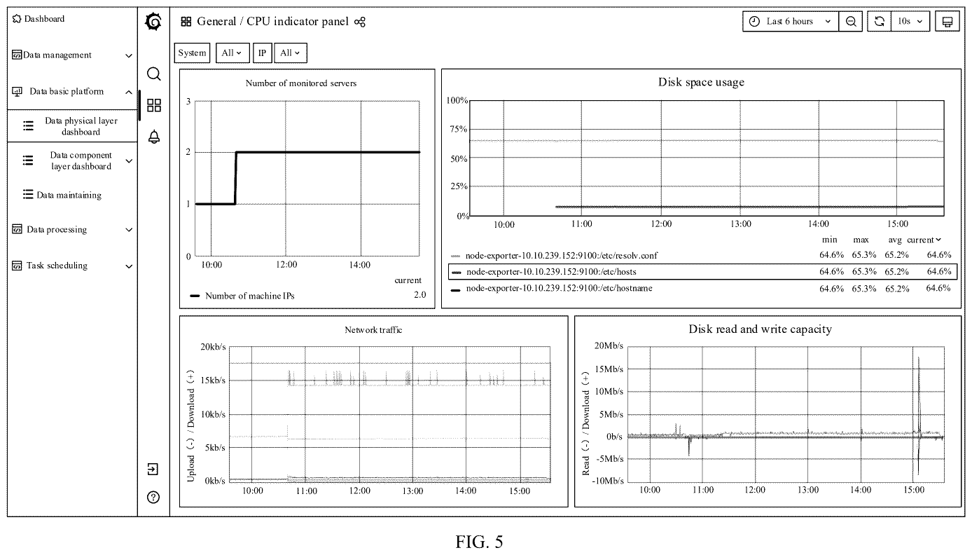

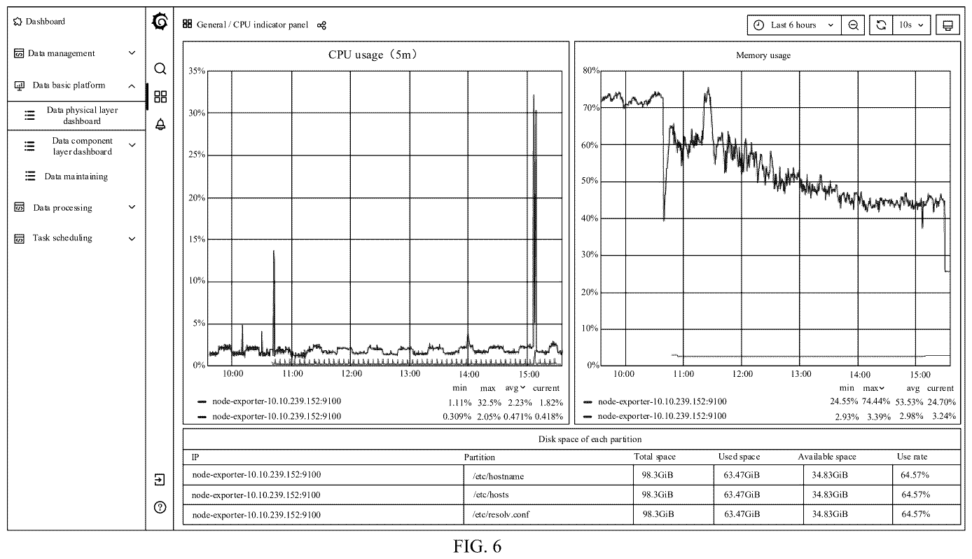

The above FIGS. 3 and 4 only show the display form of the physical-layer monitoring interface in the big data cluster when only the management server is included. If a new server is added to the big data cluster on the basis of including the management server, the physical-layer monitoring interface can be displayed as shown in FIGS. 5 and 6.

FIG. 5 is an interface schematic diagram of another physical-layer monitoring interface shown according to embodiments of the present disclosure. As shown in FIG. 5, when a server is added to a big data cluster, the number of monitored servers will change from displayed as 1 to displayed as 2, and two curves will be displayed in disk space utilization, disk read and write capacity, and network traffic, each curve corresponding to a server, to achieve monitoring of the operation of the two servers.

FIG. 6 is a schematic diagram of another physical-layer monitoring interface shown according to embodiments of the present disclosure. FIG. 6 can be obtained according to the page flipping operation in the physical-layer monitoring interface shown in FIG. 5. In the physical-layer monitoring interface shown in FIG. 6, the curves displayed in CPU usage and memory usage will become two, with each curve corresponding to a server, to achieve monitoring of the operation of two servers.

In another embodiment, according to the operational data of containers in the big data cluster, the component-layer monitoring interface is displayed, where the component-layer monitoring interface is used to display the operational data of containers in the big data cluster. In some embodiments, the component-layer monitoring interface can also be referred to as the component-layer dashboard.

In some embodiments, the component-layer monitoring interface can include multiple types to display the running status of containers corresponding to different types of big data components. For example, the component-layer monitoring interface can include an HDFS-component monitoring interface (or HDFS monitoring dashboard) used to display the operational status of containers corresponding to the HDFS component, a YARN-component monitoring interface (or YARN monitoring dashboard) used to display the operational status of containers corresponding to the YARN component, and a Clickhouse-component monitoring interface (or Clickhouse monitoring dashboard) used to display the operational status of containers corresponding to the Clickhouse component.

It should be noted that due to the relationship between Hive component(s), HDFS component(s), and YARN component(s), when the operation of HDFS component(s) and YARN component(s) is normal, there is generally no problem with the operation of Hive component(s). Therefore, in general, the Hive-component monitoring interface for the operation of containers corresponding to Hive component(s) can be omitted from the component-layer monitoring interface. In some embodiments, in order to ensure the integrity and comprehensiveness of the monitoring process, the Hive-component monitoring interface can also be set, which is not limited by the present disclosure.

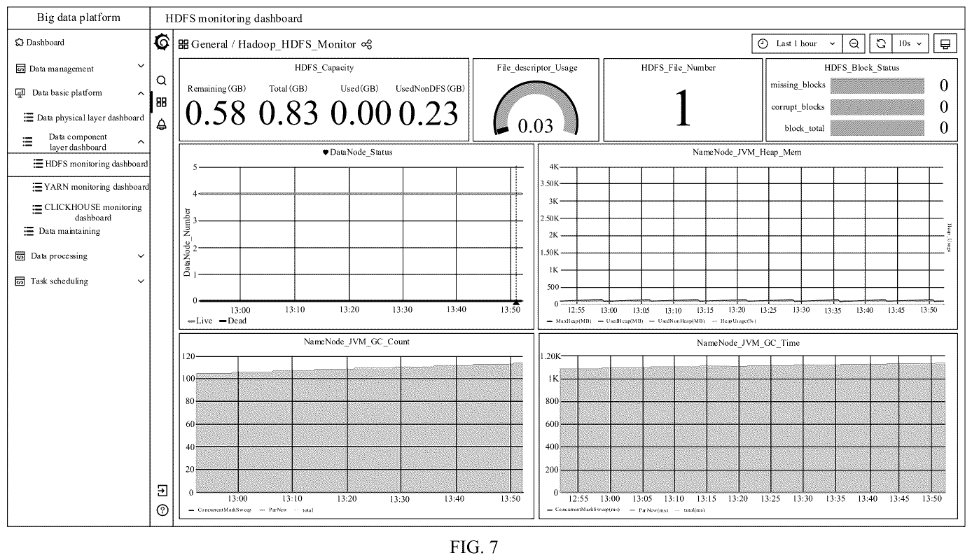

Referring to FIG. 7, FIG. 7 is a schematic diagram of an HDFS-component monitoring interface according to embodiments of the present disclosure. The HDFS-component monitoring interface shown in FIG. 7 displays big data service usage data and container status data. For example, the HDFS-component monitoring interface shown in FIG. 7 can display the usage of HDFS capacity (i.e., HDFS_Capacity), file descriptor usage (i.e., File_descriptor_Usage), number of HDFS files (i.e., HDFS_File_Number), HDFS block distribution status (i.e., HDFS_Block_Status), DataNode node status (i.e., DataNode_Status), NameNode node JVM heap memory usage (i.e., NameNode_JVM_Heap_Mem), and the number of NameNode node JVM heap garbage collections (GarbageCollection, GC) (i.e., NameNode_JVM_GC_Count) and the NameNode node JVM heap GC time (i.e., NameNode_JVM_GC_Time).

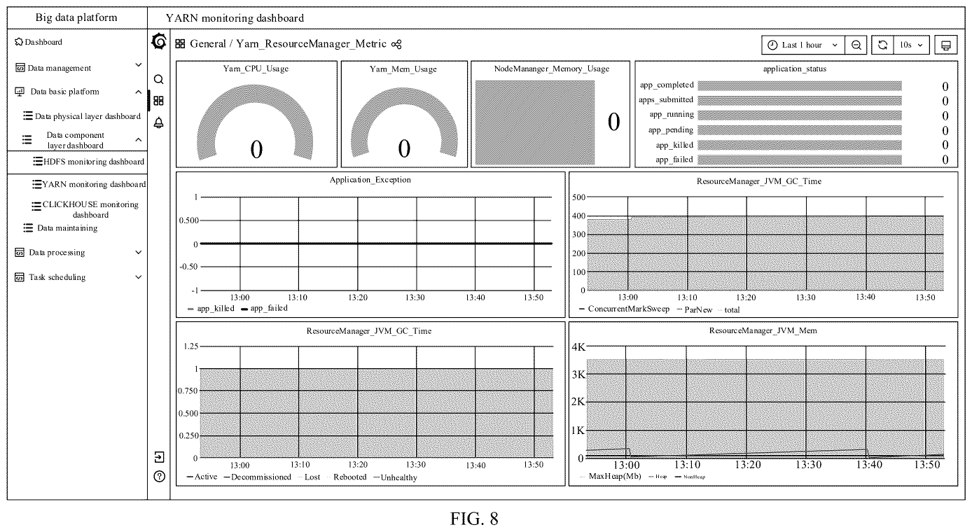

Referring to FIG. 8, FIG. 8 is a schematic diagram of a YARN-component monitoring interface according to embodiments of the present disclosure. The YARN-component monitoring interface shown in FIG. 8 displays big data service usage data and container status data. For example, the YARN-component monitoring interface shown in FIG. 8 can display the YARN CPU usage (i.e., YARN_CPU_Usage), YARN memory usage (i.e., YARN_Mem_Usage), node memory usage (i.e., NodeManager NodeManager_Memory_Usage), application status in YARN (i.e., Application_Status), application exceptions in YARN (i.e., Application_Exception), ResourceManager node JVM heap GC time (i.e., ResourceManager_JVM_GC_Time), NameNode node status (i.e., NodeManager_Status, and the usage of ResourceManager node JVM heap memory (i.e., ResourceManager_JVM_Mem).

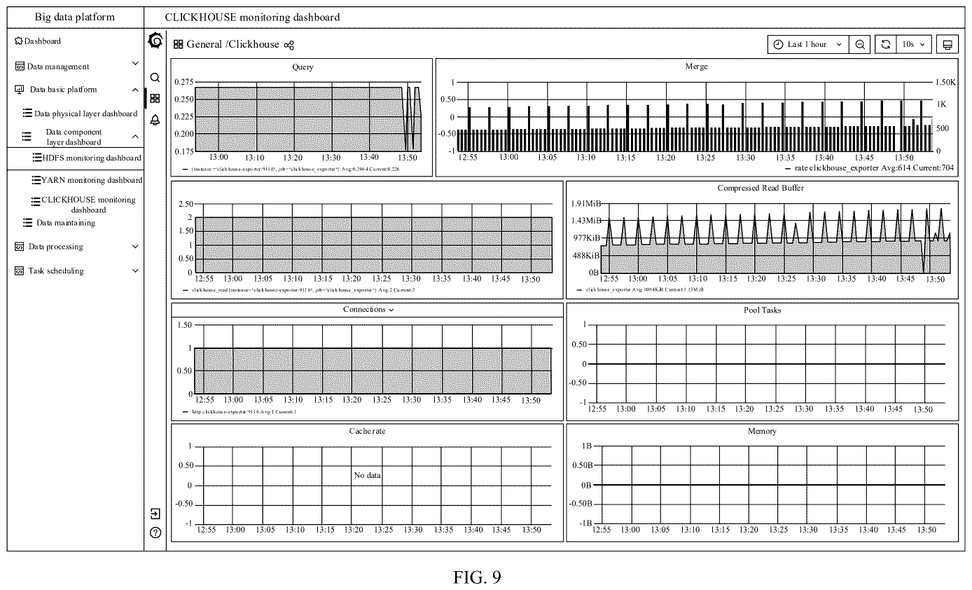

Referring to FIG. 9, FIG. 9 is a schematic diagram of an Clickhouse-component monitoring interface according to embodiments of the present disclosure. The Clickhouse-component monitoring interface shown in FIG. 9 displays big data service usage data and container status data. For example, the Clickhouse-component monitoring interface shown in FIG. 9 can display the number of Clickhouse queries (i.e., Quary), the number of Clickhouse merges and rows/minute (i.e., Merge), the read/write status of Clickhouse (i.e., Read\Write), the Clickhouse compressed read buffer size/minute (i.e., Compressed Read Buffer), the current number of Clickhouse connections (i.e., Connections), the number of Clickhouse tasks (i.e., Pool Tasks), the cache rate of Clickhouse tags (i.e., Cache rate), and the Clickhouse memory usage (i.e., Memory).

It should be noted that since the monitoring service corresponding to the server has already been deployed when the server is deployed, there is no problem of being unable to monitor the operation of the server in the big data cluster through the monitoring interface. However, the monitoring service corresponding to the container needs to wait for the deployment of the container corresponding to the big data component to be completed before deployment. Therefore, when monitoring the operation of a big data cluster through the monitoring interface, there may be situations where the operational data of the component cannot be viewed since the component have not completed deployment. Referring to FIG. 10, FIG. 10 is a schematic diagram of a component-layer monitoring interface according to embodiments of the present disclosure. As shown in FIG. 10, for components that have not completed deployment, a prompt message “component not yet deployed, cannot be viewed temporarily” can be displayed.

For ease of understanding, the following will introduce the process of deploying physical-layer monitoring services to display physical-layer monitoring pages and deploying component-layer monitoring services to display component-layer monitoring pages. The deployment of the physical-layer monitoring service includes deploying the first data collecting service, monitoring and alerting service, and data visualizing and analyzing service, and the deployment of the component-layer monitoring service includes deploying the second data collecting service, monitoring and alerting service, and data visualizing and analyzing service.

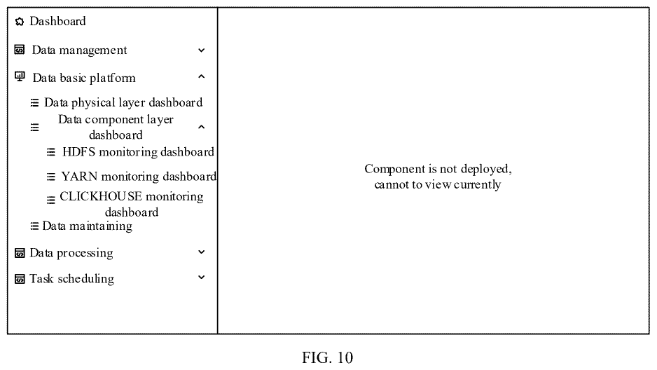

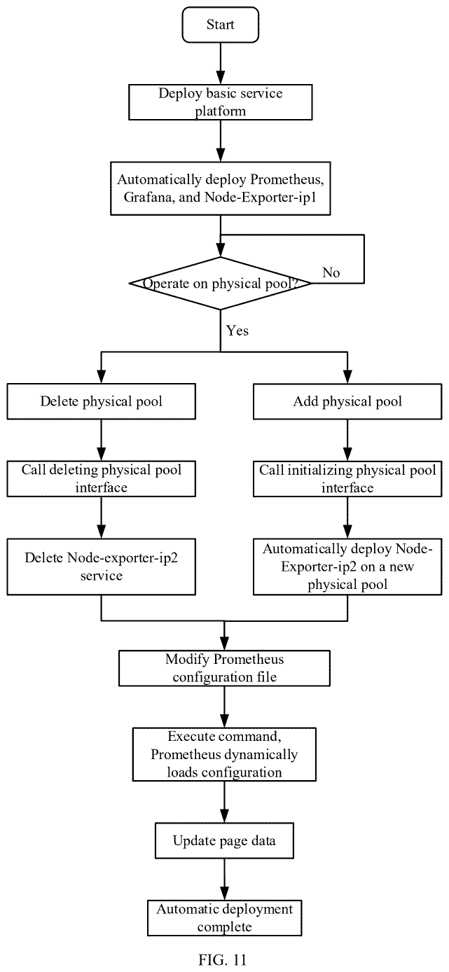

Referring to FIG. 11, FIG. 11 is a flowchart of a deployment process of a physical-layer monitoring service according to embodiments of the present disclosure. As shown in FIG. 11, after the deployment of the basic service platform of the big data cluster is completed, Prometheus service, Grafana service, and Node-Exporter-ip1 service (ip1 indicates the identification of the management server) can be automatically deployed on the management server for the big data cluster. When an operation on a physical pool is detected, if a physical pool deleting operation on server ip2 is to be performed, the physical-pool-deleting interface can be called to delete the Node-Exporter-ip2 service; if the operation of adding a physical pool to the new server ip2 is to be performed, the physical-pool-initializing interface can be called to automatically deploy the Node-Exporter-ip2 service on the new physical pool (i.e., the newly added server ip2 in the big data cluster). After the deletion or deployment of the Node-Exporter-ip2 service is completed, the first configuration file maintained by the Prometheus service can be modified, and the Prometheus service can execute corresponding commands to dynamically load the first configuration file to obtain the latest monitoring list (used to indicate the data source of data that needs to be crawled), such that the physical-layer monitoring page can be displayed according to the latest monitoring list.

The information recorded in the first configuration file before modification can be:

static_configs:
- targets: [node-exporter-ip1:9100]

The information recorded in the modified first configuration file can be:

static_configs:
- targets: [node-exporter-ip1:9100, node-exporter-ip2:9100]

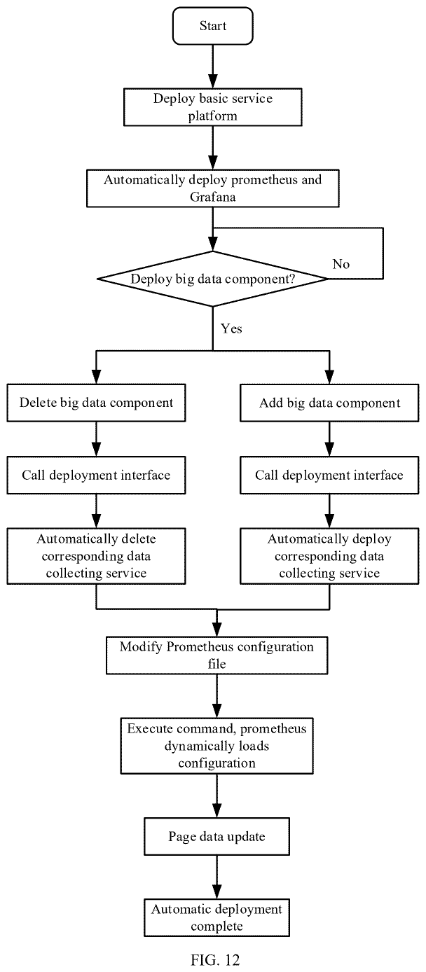

Referring to FIG. 12, FIG. 12 is a flowchart of a deployment process of a component-layer monitoring service according to embodiments of the present disclosure. As shown in FIG. 12, after the deployment of the basic service platform of the big data cluster is completed, Prometheus service, and Grafana service can be automatically deployed on the management server for the big data cluster. When a deployment operation of a new type of big data component is detected, if the operation is to delete the big data component, the deployment interface can be called to automatically delete the data collecting service corresponding to the big data component; if the operation is to add a big data component, the deployment interface can be called to automatically deploy the corresponding data collecting service for the newly added container. After the deletion or deployment of the data collecting service is completed, the first configuration file maintained by the Prometheus service can be modified, and the Prometheus service can execute corresponding commands to dynamically load the first configuration file, in order to achieve data updates on the component-layer monitoring page.

Taking the addition of HDFS-exporter service as an example, when modifying the configuration file of Prometheus, the following information can be added to the first configuration file:

```
- job_name: “hdfs_exporter”
  static_configs:
    - targets: [hdfs-exporter:9131]
```

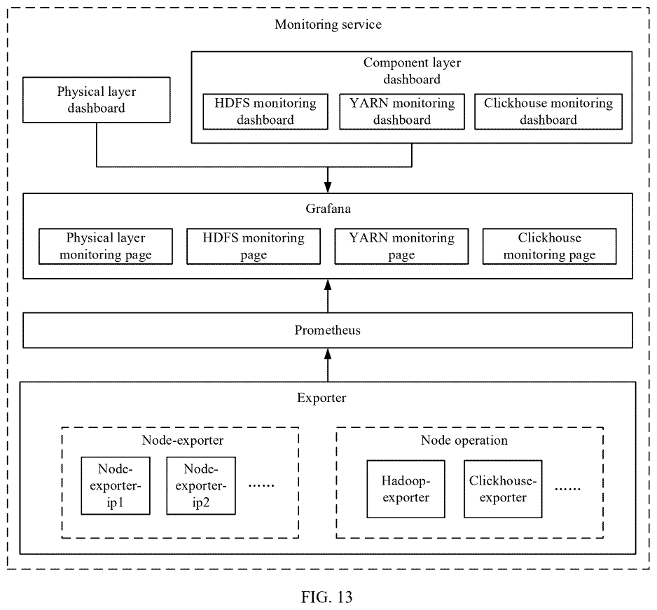

According to the above embodiments, a data flow of the implementation process of the monitoring service provided by the present disclosure can be seen in FIG. 13. FIG. 13 is a schematic diagram of a data flow of a monitoring service according to embodiments of the present disclosure. As shown in FIG. 13, the operational data of the server and container can be collected through the Exporter service, for example, the operational data of the server can be collected through the Node-exporter service (including Node-exporter-ip1, Node-exporter-ip2, etc.), and the operational data of the container corresponding to the big data component can be collected through the Hadoop-exporter service and Clickhouse-exporter service. The Prometheus service crawls the operational data collected by the Exporter service, and the Prometheus service passes the crawled data to the Grafana service. A physical-layer dashboard and a component-layer dashboard (including an HDFS monitoring dashboard, a YARN monitoring dashboard, and a Clickhouse monitoring dashboard) have been pre-configured in the Grafana service, such that the physical-layer monitoring page, the HDFS monitoring page, the YARN monitoring page, and the Clickhouse monitoring page can be displayed according to the data transmitted by the Prometheus service.

In some embodiments, if there is an abnormality in the operational data collected through the data collecting service, an alarm message can be transmitted through the monitoring and alerting service, such that the operation and maintenance personnel can handle the abnormality in a timely manner.

The above embodiments mainly introduce the process of deploying the monitoring service for the big data cluster. In more embodiments, a gateway proxy service can also be deployed for the big data cluster. The gateway proxy service is used to provide access functions for users outside the big data cluster. The gateway proxy service can be a Knox service.

It should be noted that the deployment of the big data cluster in the present disclosure is implemented based on the OverLay network, and the Hostname and port provided by the OverLay network are inaccessible externally. Only by deploying the Knox service in the OverLay network and transmitting a read and write request externally to the Knox service can communication with the big data cluster be achieved through the Knox service.

Taking the process of accessing the container corresponding to the HDFS component as an example, the HDFS component can include a NameNode node and a DataNode node. NameNode can be seen as a manager in a distributed file system, mainly responsible for managing the namespace of the file system, cluster configuration information, and replication of storage blocks. The NameNode node can store the Meta-data of the file system in memory. This information mainly includes file information, the information of a file block corresponding to each file, and the information of each file block in the DataNode. DataNode is the basic unit of file storage. The Datanode stores file blocks in the local file system, saves the Meta-data of file blocks, and periodically transmits all existing file block information to NameNode.

When an external agent (Client) initiates a file read and write request to NameNode, NameNode will return the DataNode information managed by the Client to the Client according to the file size and file block configuration. The Client divides the file into multiple file blocks and writes the file blocks into each DataNode block according to the address information of the DataNode. However, in the OverLay network, the DataNode connection information returned by NameNode is the Hostname and port within the OverLay network, which cannot be accessed externally. To achieve communication of the external network and the DataNode node, only through deploying the Knox service in the OverLay network, and transmitting externally the read and write request to the Knox service, the communication with the DataNode node be achieved through the Knox service, thereby achieving data read and write.

In some embodiments, when deploying the gateway proxy service for the big data cluster, the gateway proxy service can be deployed on the management server of the big data cluster.

In some embodiments, if a new server and/or a new container is added to the big data cluster, a corresponding gateway proxy service need to be deployed for the newly added server and/or container.

However, it should be noted that the gateway proxy service is also a universal basic service. Therefore, for a big data cluster, only one-time deployment on the management server for the gateway proxy service is required. When the gateway proxy service is deployed subsequently for the new server and/or container, only the deployed gateway proxy service needs to be updated.

In some embodiments, the gateway proxy service can maintain a second configuration file. The second configuration file can be used to record the objects that the gateway proxy service is to serve. When the deployed gateway proxy service is updated, the second configuration file maintained by the gateway proxy service can be updated to include the newly added server and/or container as the object to be served by the gateway proxy service, to achieve the effect of deploying the gateway proxy service for the newly added server and/or container.

It should be noted that in the actual operation process of the big data cluster, big data services are mainly provided through containers. Therefore, in general, external access is mostly regarding containers. Therefore, deploying the gateway proxy service is necessary to be performed under a situation where containers corresponding to big data components are to be deployed or have already deployed in the big data cluster, and the component parameters of the deployed big data components can be used as configuration parameters, to deploy the gateway proxy service.

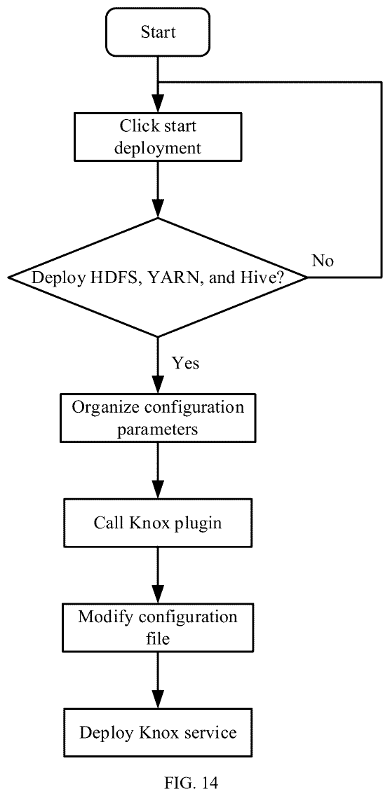

Referring to FIG. 14, FIG. 14 is a flowchart of a deployment process of a gateway proxy service according to embodiments of the present disclosure. As shown in FIG. 14, when the user triggers the start deployment operation in the deployment interface to deploy the big data cluster, it can be determined whether the current object to be deployed includes a container corresponding to an HDFS component, a YARN component, or a Hive component. In the case of that the container corresponding to the HDFS component, YARN component, or Hive component is included in the current object to be deployed, the Knox plugin can be called to modify the second configuration file according to the component parameters of the HDFS component, YARN component, or Hive component to be deployed, thereby achieving the deployment of the Knox service.

After the deployment of the gateway proxy service, users can obtain the network address of the deployed container through the deployed gateway proxy service, such that the users can access the big data cluster through the obtained network address.

In some embodiments, an information viewing control can be provided in the deployment interface. The information viewing control can be used to provide a viewing function for the container network address, such that users can obtain the container network address through the information viewing control. In response to the triggering operation of the information viewing control, the network address of the container displayed in the deployment interface is displayed.

In some embodiments, the information viewing control can be set in the deployment resource pool region, such that when the network address of the container displayed is displayed in the deployment interface, the network address of the container displayed in the deployment resource pool region can be displayed.

Taking the deployment interface shown in FIG. 2 as an example, the button labeled as “Connection Information” in the deployment interface is the information viewing control. Users can obtain the network address of a deployed container in the big data cluster by triggering the button labeled as “Connection Information”.

In some embodiments, when the user triggers the information viewing control, the computing device can display the information viewing interface to display the network address of the deployed container in the big data cluster to the user through the information viewing interface.

It should be noted that different types of containers correspond to different types of network addresses. If an HDFS component, a YARN component, and a Hive component are deployed, the Knox proxy address will be returned. For the HDFS component and YARN component, the URL address of the proxy web page is returned, and for the Hive component, the URL address of the proxy Java Database Connectivity (JDBC) is returned. If the Clickhouse component is deployed, the JDBC URL address of the Clickhouse can be returned to display the returned network address on the information viewing interface.

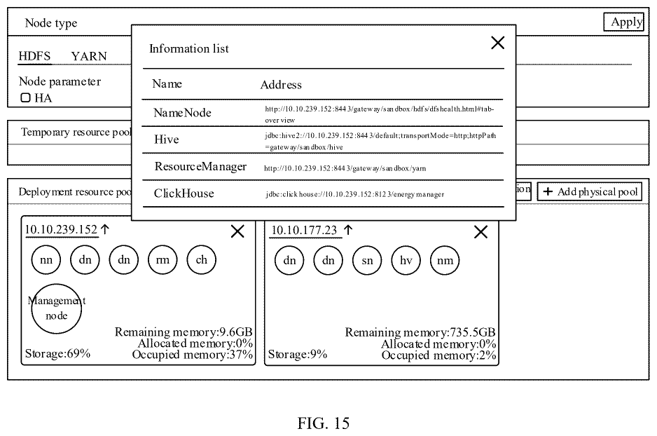

In the case where the HDFS component, the YARN component, the Hive component, and the Clickhouse component have been deployed in the big data cluster, the information viewing interface can be seen in FIG. 15. FIG. 15 is a schematic diagram of an information viewing interface according to embodiments of the present disclosure, as shown in FIG. 15. The network addresses of the containers corresponding to the NameNode node and ResourceManager node are the URL addresses of the proxy web pages, the network address of the container corresponding to the Hive node is the URL address of the proxy JDBC, and the network address of the container corresponding to the Clickhouse node is the URL address of the proxy JDBC.

In some embodiments, after the network address of the container is obtained, the user can copy the URL address of the web page to the browser, enter a username and password, and access the management pages of the HDFS and YARN components. Alternatively, the URL address and username password of the proxy JDBC can be configured through a database connection tool to connect the Hive and Clickhouse components for data analysis.

Referring to FIG. 16, FIG. 16 is a flowchart of obtaining a container network address according to embodiments of the present disclosure. As shown in FIG. 16, if a user requests to view connection information, the computing device can query the network deployment status in the big data cluster. Since the HDFS component, the YARN component, and the Hive component need to be accessed through the proxy Knox service, if the deployed services include services corresponding to the HDFS component, the YARN component, and the Hive components, the Knox proxy URL address can be returned. If the deployed services are services corresponding to the HDFS component or the YARN component, the returned URL address is the URL address of the web page of the proxy Knox. If the deployed service is the service corresponding to the Hive component, the JDBC URL address of the proxy Knox can be returned. If the deployed service only includes the service corresponding to the Clickhouse component, the JDBC URL address of the Clickhouse can be returned.

It should be noted that the URL addresses corresponding to the HDFS component and the YARN component are the URL addresses of web pages. Therefore, the corresponding web pages can be accessed by copying the URL addresses of web pages to the browser. The URL addresses corresponding to the Hive and Clickhouse components are the proxy JDBC URL addresses, which can be accessed by connecting to the client through a database.

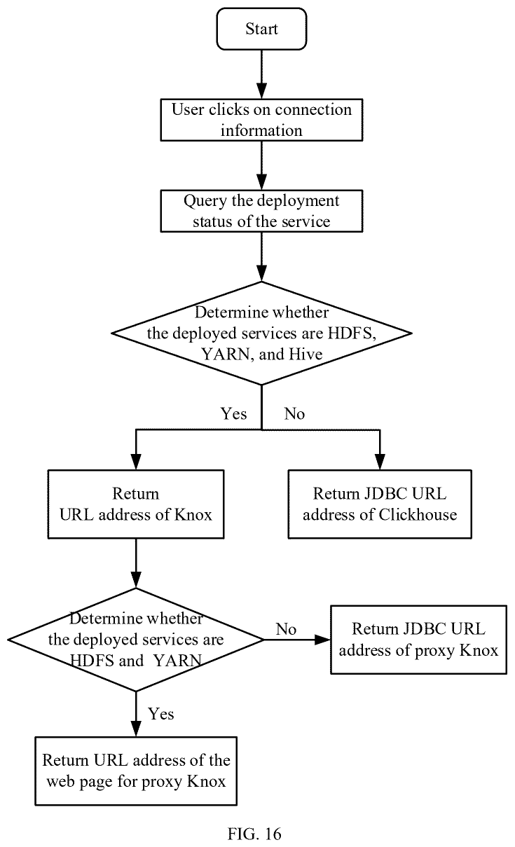

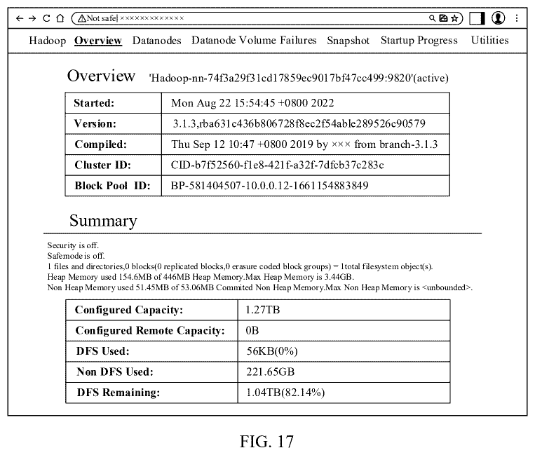

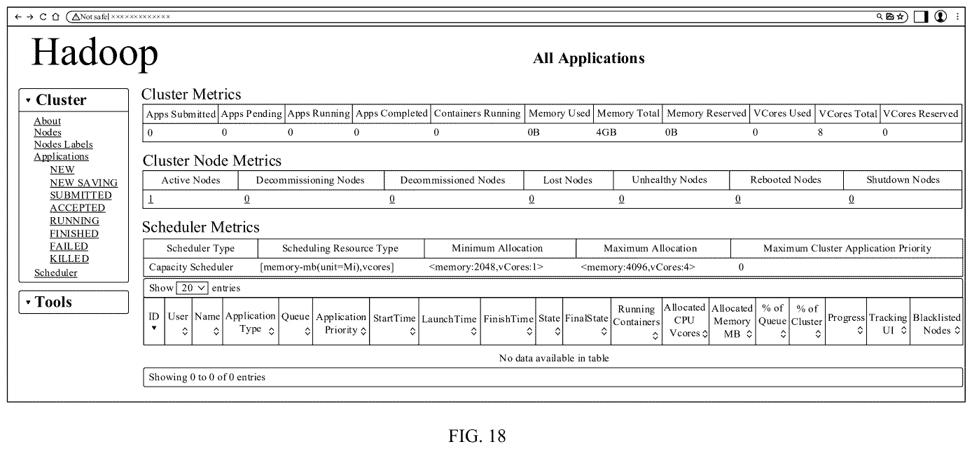

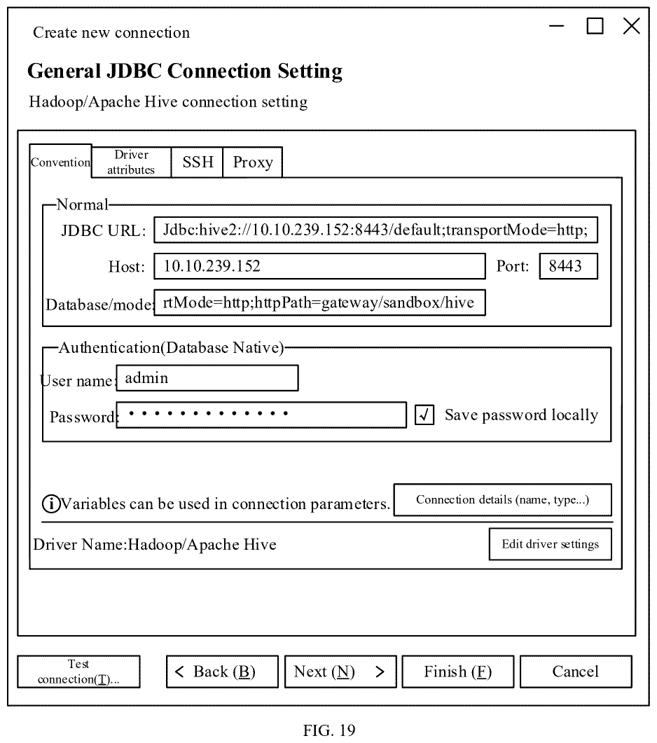

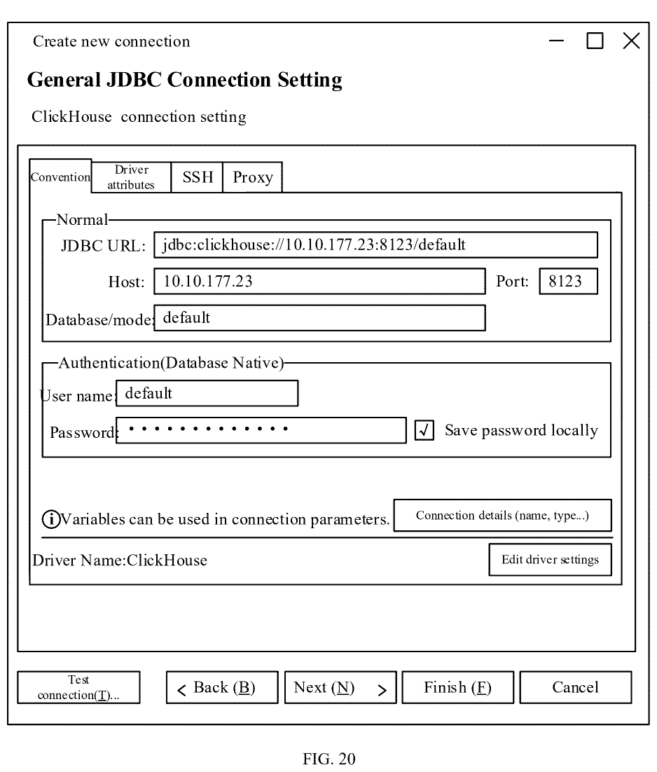

The interface diagrams for managing different components can be found in FIGS. 17 to 20. FIG. 17 is a schematic diagram of a web interface for managing HDFS component(s) according to embodiments of the present disclosure, FIG. 18 is a schematic diagram of a web interface for managing YARN component(s) according to embodiments of the present disclosure, FIG. 19 is a schematic diagram of a client interface for managing Hive component(s) according to embodiments of the present disclosure, and FIG. 20 is a schematic diagram of a client interface for managing Clickhouse component(s) according to embodiments of the present disclosure.

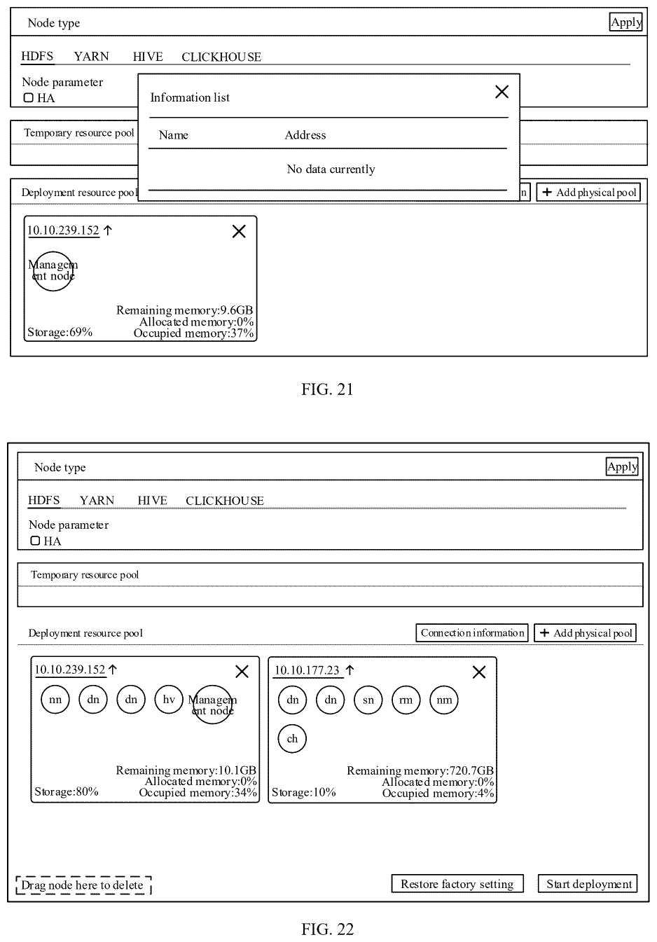

In addition, if a big data component has not been deployed in the big data cluster, the information viewing interface shown in FIG. 21 can be displayed, as shown in FIG. 21. FIG. 21 is a schematic diagram of an information viewing interface according to embodiments of the present disclosure. In the information viewing interface shown in FIG. 21, a prompt message “No data currently” is displayed, indicating that the big data component has not been deployed in the big data cluster.

Through the above embodiments, users can achieve the purpose of accessing the big data cluster from external sources to enhance the flexibility of the big data cluster usage process.

In some embodiments, the present disclosure can further provide a function for overall migration of services deployed on management servers. For example, in the event of an alarm, there may be a situation where the storage resources of the management server are insufficient. As the core of the entire big data cluster, if the storage resources of the management server are insufficient, it may lead to abnormal functionality of the entire big data cluster. In order to ensure the smooth operation of the big data cluster, a service migration function can be provided, so that the services deployed on the management server can be migrated as a whole through the service migration function, to deploy the services deployed on the management server to other servers with more storage resources.

In some embodiments, the management node corresponding to the management server can be displayed in the deployment interface, such that users can trigger the service migration process by dragging and dropping nodes in the deployment interface.

In some embodiments, multiple physical pools (each corresponding to a server) are displayed in the deployment resource pool of the deployment interface. When the management node corresponding to the management server is displayed, the management node can be displayed in the physical pool corresponding to the management server.

Users can migrate a service deployed on the management server to another server by dragging and dropping the management node displayed in the corresponding physical pool on the management server to another physical pool.

In some embodiments, in response to the drag and drop operation on the management node in the deployment interface, configuration data of the management server is copied to a destination server indicated by the drag and drop operation, to achieve the goal of migrating the service deployed on the management server to the destination server. Where the destination server is the server corresponding to the physical pool where the drag and drop operation ends.

In some embodiments, a deployment control can be provided in the deployment interface, and users can trigger the deployment control after moving the management node from the management server to the destination server to trigger the backend service migration operation. Referring to FIG. 22, FIG. 22 is a schematic diagram of a deployment interface according to embodiments of the present disclosure. In the deployment interface shown in FIG. 22, the button labeled “Start Deployment” is the deployment control.

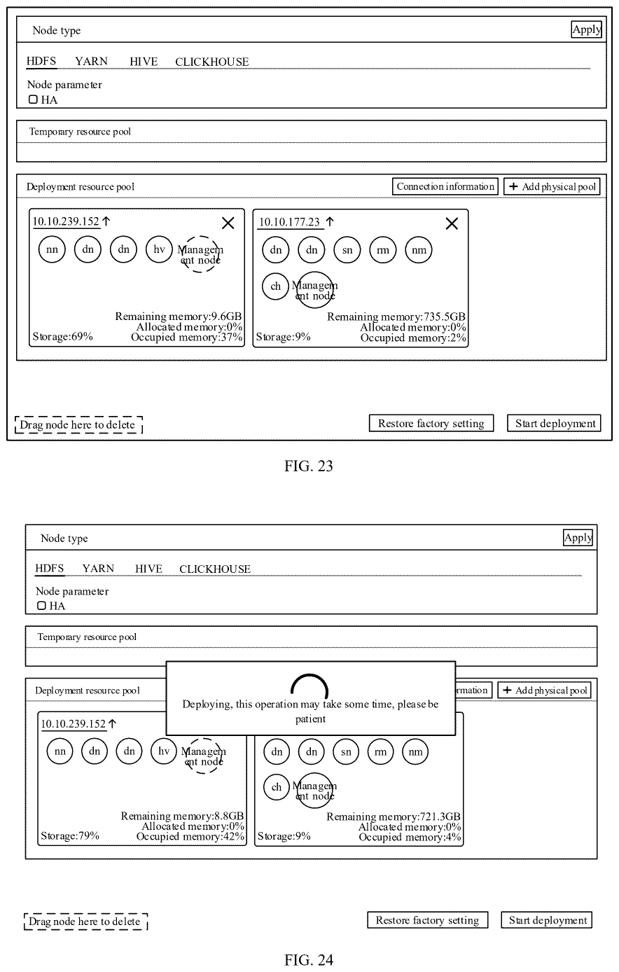

Below will introduce the drag and drop process of the management node in conjunction with the deployment interface shown in FIG. 22. As shown in FIG. 22, the server with IP address 10.10.239.152 is the management server, and the management node is displayed in the physical pool corresponding to the management server. If a server with an IP address of 10.10.177.23 is the destination server, after the user drags the management node from the physical pool corresponding to the management server to the physical pool corresponding to the destination server, the deployment interface can be updated to the form shown in FIG. 23, as shown in FIG. 23. FIG. 23 is a schematic diagram of a deployment interface according to embodiments of the present disclosure. In the deployment interface shown in FIG. 23, the management node in the physical pool corresponding to the management server is displayed as a to-be-moved state (indicated by a dashed line in FIG. 23), and the management node can be displayed in the physical pool corresponding to the destination server. However, in the state shown in FIG. 23, only the node at the interface level is moved, and the real service has not been migrated yet.

In some embodiments, users can trigger the “Start Deployment” button as a deployment control in the deployment interface shown in FIG. 23 to trigger the migration process of the service.

During the service migration process, a prompt message can be displayed to prompt users to wait for the service migration to complete. For example, in response to the drag and drop operation on the management node in the deployment interface, the prompt information is displayed, where the prompt information is configured to prompt that the management server and the destination server are being redeployed.

Referring to FIG. 24, FIG. 24 is a schematic diagram of a deployment interface according to embodiments of the present disclosure. In the deployment interface shown in FIG. 24, a prompt message “Deploying, this process may take some time, please be patient” is displayed.

It should be noted that the process of migrating services is the process of copying configuration data from the management server to the destination server. After the data copy is completed, it can be considered that the migration of the management node is complete. At this time, the computing device can, according to an instruction of the drag and drop operation on the management node in the deployment interface, automatically delete the management node corresponding to the management server from the deployment interface, and display the management node corresponding to the destination server in the deployment interface.

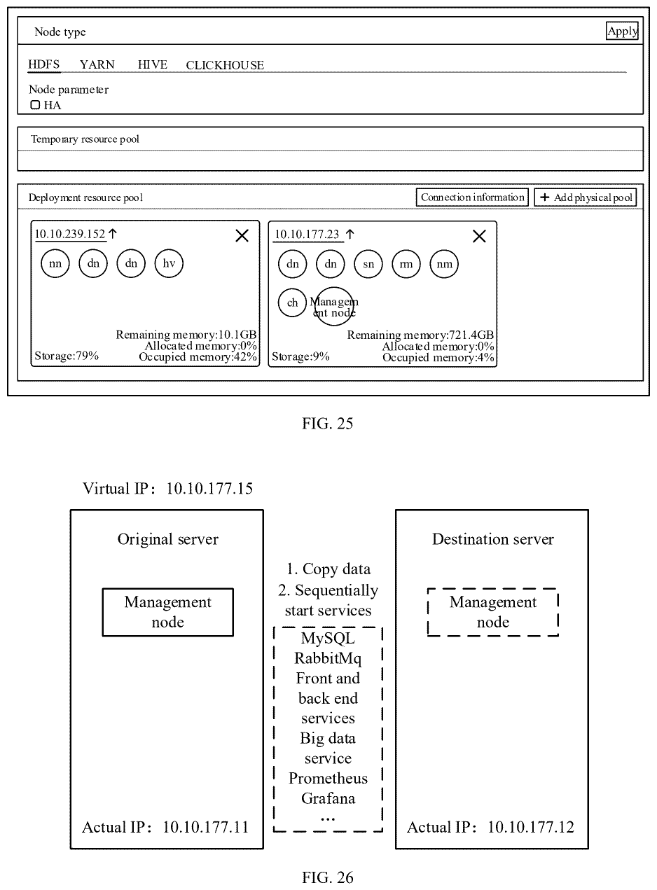

For example, the deployment interface can be updated to the form shown in FIG. 25. Referring to FIG. 25, FIG. 25 is a schematic diagram of a deployment interface according to embodiments of the present disclosure. In the deployment interface shown in FIG. 25, the physical pool corresponding to the original management server (i.e., server with IP address 10.10.239.152) no longer has the management node, and the physical pool corresponding to the destination server (i.e., server with IP address 10.10.177.23) displays the management node. At this time, the server with IP address 10.10.177.23 can serve as the new management server in the big data cluster.

In some embodiments, to ensure that users can normally use the services provided by the big data cluster during the service migration process, to achieve the goal of service migration without user awareness, a virtual Internet Protocol (IP) technology can be used.

A virtual IP is an IP address that does not correspond to a specific computer or computer network card. All packets transmitted to this IP address will eventually pass through the real network card to reach the destination process of the destination host. A common use case of the virtual IP is in the application of high availability (HA) in a system. Usually, a system will go down due to daily maintenance or unexpected downtime. In order to improve the high availability of external services, the host and backup mode will be used for high availability configuration. When the host M that provides services goes down, the service will switch to the backup host S to continue providing services to the outside, which users are not aware of. In this case, the IP address provided by the system to the client will be a virtual IP. When the host M goes down, the virtual IP will float to the backup host and continue to provide services. In this case, a virtual IP is not corresponding to a specific computing host or a specific physical network card, but rather a virtual or logical concept that can move and float freely. This not only shields the internal details of the system from the outside, but also provides convenience for the maintainability and scalability of the system.

That is, a virtual IP address can be set up in advance for the management server. However, since the virtual IP address is not the IP address of any real server in the network environment, in order to ensure that the virtual IP address can correspond to the server in the network environment, it can be achieved by maintaining Address Resolution Protocol (ARP) cache.

In some embodiments, each server can maintain an ARP cache to store the correspondence between IP addresses and physical addresses (i.e., Media Access Control addresses, MAC addresses) within the same network (i.e., ARP cache table). When transmitting data, servers in Ethernet will first query the MAC address corresponding to the target IP from this cache table, and then transmit data to the server corresponding to this MAC address.

Therefore, the correspondence between virtual IP addresses and MAC addresses of real servers can be maintained through ARP caching, so that real servers in the network can be found according to virtual IP addresses.

In some embodiments, after the service migration is completed, the virtual IP address pre-set for the management server can be deleted, and the virtual IP address can be configured to the destination server, to switch between the servers represented by the virtual IP address, thereby deleting the configuration data in the management server.

In some embodiments, when switching a server represented by the virtual IP address from one server (referred to as the original server) to another server (referred to as the destination server), the destination server can transmit an ARP broadcast to servers within the same network. All servers that receive the broadcast will automatically refresh their maintained ARP cache table to achieve service switching, such that a request can be transmitted to the corresponding service of the new host through the virtual IP address in the future.

The above embodiments are to illustrate the switching of servers represented by virtual IP addresses after service migration is completed. In more embodiments, before switching servers represented by virtual IP addresses, the service corresponding to the configuration data can be started in the destination server according to the configuration data copied from the management server. If each service in the destination server starts normally, the virtual IP address set for the management server in advance is deleted and configure the virtual IP address to the destination server.

It should be noted that the present disclosure mainly introduces the big data service and the monitoring service deployed on a management server. Generally, database services (such as MySQL services), message queue services (such as RabbitMq services), big data platform front-end and back-end services, etc. will also be deployed on the management server. When migrating services from the management server to the destination server, all of these services need to be migrated.

In some embodiments, when starting various services on the destination server, the various services deployed on the destination server can be started in the order of “database service→message queue service→big data service→big data platform front-end and back-end services→monitoring service”. Alternatively, other start sequences can be used to start various services. For example, the start sequence of front-end and back-end services and big data services on the big data platform can be swapped. However, it is necessary to ensure that basic services such as database services and message queue services need to be started before the front-end and back-end services and big data services on the big data platform, and additional functions such as monitoring services can generally be started last.

By detecting the start status of the service, virtual-IP-address switching can be carried out when the migrated service can start normally, ensuring that services can be provided to users before and after the virtual-IP-address switching, to achieve the goal of imperceptible to users.

Taking the real IP address of the original server as 10.10.177.11, the real IP address of the destination server as 10.10.177.12, and the virtual IP address as 10.10.177.15 as examples, the process of switching virtual IP addresses can be described as follows.

Referring to FIG. 26, FIG. 26 is a flowchart of a virtual-IP-address switching process according to embodiments of the present disclosure. As shown in FIG. 26, the management node is set on the original server with an IP address of 10.10.177.11. When the original server provides services to the outside, it will use the virtual IP address of 10.10.177.15 as its own IP address for identification. When migrating the management node to the destination server with an IP address of 10.10.177.12, the data on the original server will be copied first. After the data is copied, the services will be started on the destination server in the order of “MySQL service->RabbitMq service->Big data platform front-end and back-end service->Big data service->Monitoring service (including Prometheus service and Grafana service)”.

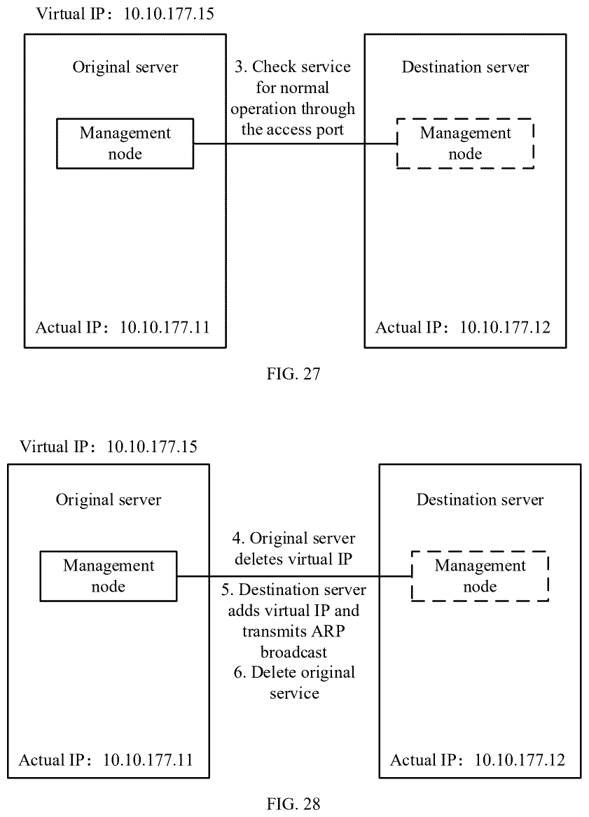

Referring to FIG. 27, FIG. 27 is a flowchart of a virtual-IP-address switching process according to embodiments of the present disclosure. As shown in FIG. 27, after starting each service on the destination server, the service can be checked for normal operation through the access port.

If the service is normal, the process shown in FIG. 28 can be entered. As shown in FIG. 28. FIG. 28 is a flowchart of a virtual-IP-address switching process according to embodiments of the present disclosure. As shown in FIG. 28, the virtual IP address can be deleted from the original server, and the virtual IP address can be added to the destination server. The destination server transmits an ARP broadcast to other servers in the same network to update the ARP cache, thereby achieving virtual IP switching. After the virtual IP switch is completed, the services deployed on the original server can be deleted.

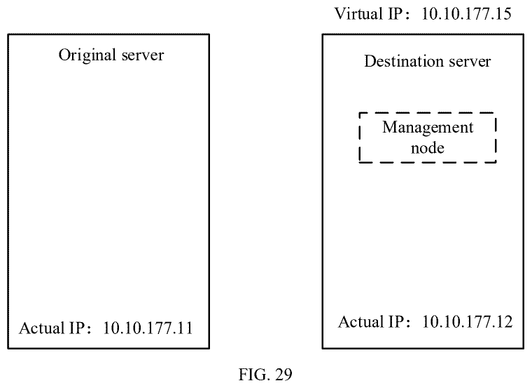

Referring to FIG. 29, FIG. 29 is a schematic diagram of a virtual-IP-address switching result according to an embodiment of the present disclosure. As shown in FIG. 29, after the switching, the management node will be located on the destination server, and the virtual IP address 10.10.177.15 will be used as the IP address used by the destination server during communication.

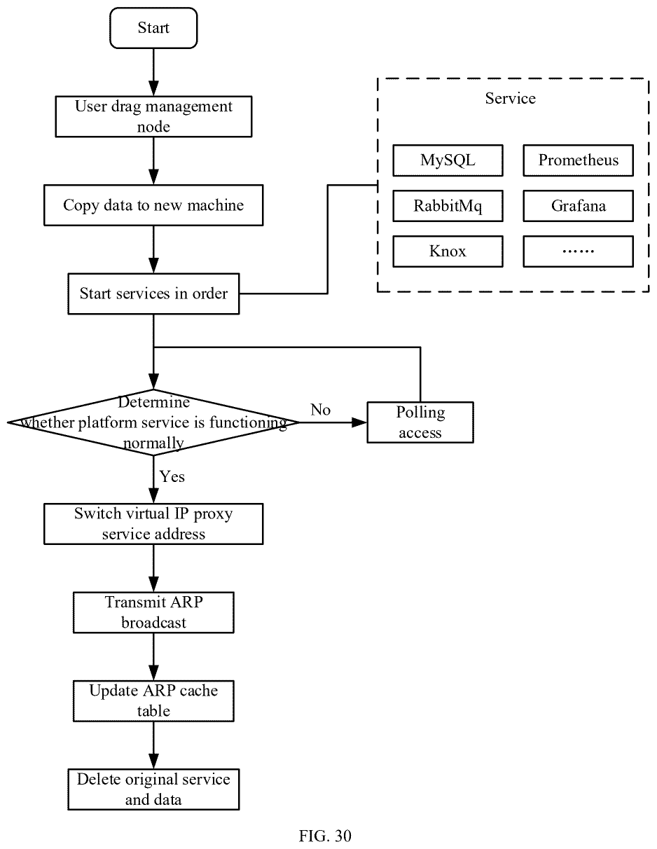

The management-node migration process provided in the above embodiment can be seen in FIG. 30. FIG. 30 is a flowchart of a management-node migration process according to embodiments of the present disclosure. As shown in FIG. 30, if the user drags the management node on the deployment interface (such as dragging the management node from the original machine to the new machine), the computing device can copy the data from the original machine to the new machine and start the services in sequence on the new machine (including MySQL service, RabbitMq service, Knox service, Prometheus service, Granafa service, etc.). By using polling access to determine whether the services deployed on the new machine are normal, if the services deployed on the new machine are normal, switch the servers represented by the virtual IP address and transmit the ARP broadcast to the machines in the network to update the ARP cache table and complete the switching of the virtual IP address. After the virtual IP address switch is completed, the services and data on the original machine can be deleted.

The above embodiments mainly introduce the service migration function provided by the present disclosure from the perspective of dealing with management server anomalies through service migration. In more embodiments, users can also migrate the services deployed on the management server as a whole according to actual technical requirements, even in the absence of anomalies in the big data cluster, which is not limited in the present disclosure.

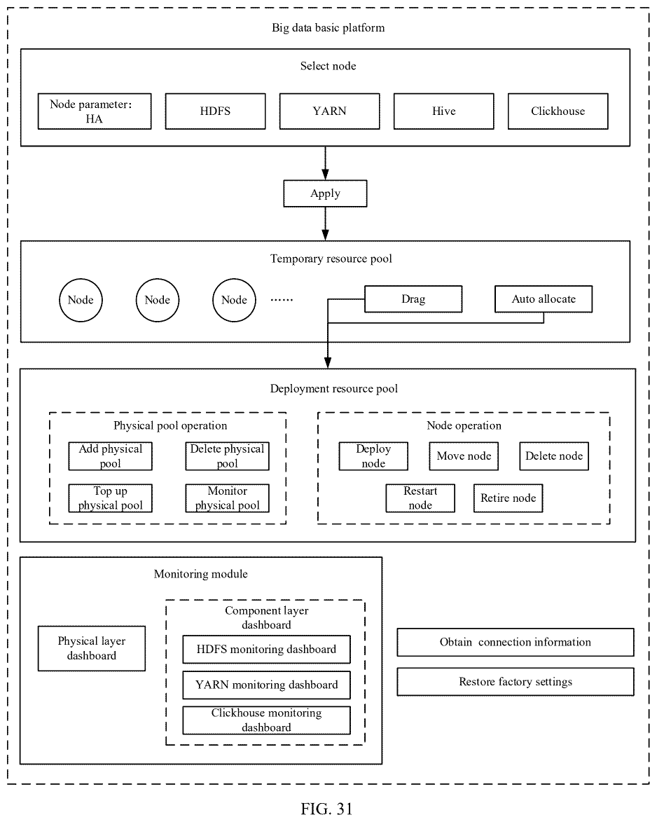

Referring to FIG. 31, FIG. 31 is a schematic structural diagram of a method for deploying a big data cluster according to embodiments of the present disclosure. As shown in FIG. 31, users can select the type and parameter of to-be-deployed node in the deployment interface, and the selected nodes will be displayed in the temporary resource pool of the deployment interface. Nodes in the temporary resource pool can be transferred to the deployment resource pool by dragging or automatic allocation. Users can operate on the physical pools and nodes in the deployment resource pool. Operations on the physical pool can include adding physical pools, deleting physical pools, topping physical pools, and monitoring physical pool operations. Operations on the node can include node deployment operations, node deletion operations, node movement operations, and node retirement operations. Moreover, the present disclosure can provide a physical-layer dashboard and a component-layer dashboard (including HDFS monitoring dashboard, YARN monitoring dashboard, and Clickhouse monitoring dashboard), such that users can view the monitored operational data through the dashboard. In addition, functions such as viewing connection information and restoring factory settings can also be obtained.

Through the solution provided by the present disclosure, it is possible to provide the automated deployment monitoring service and gateway proxy service on the basis of automated deployment of big data components, providing users with a complete set of big data basic platforms without logging into the server. When big data components are automatically deployed By dragging and clicking on the front-end page, the monitoring of machine operational status, the monitoring of component service functions, and the gateway proxy function can be automatically completed, greatly reducing the technical threshold for big data operation and maintenance, and improving service security and customer experience.

Corresponding to the embodiments of the aforementioned methods, the present disclosure also provides embodiments of a corresponding apparatus for deploying a big data cluster and a computing device thereof.

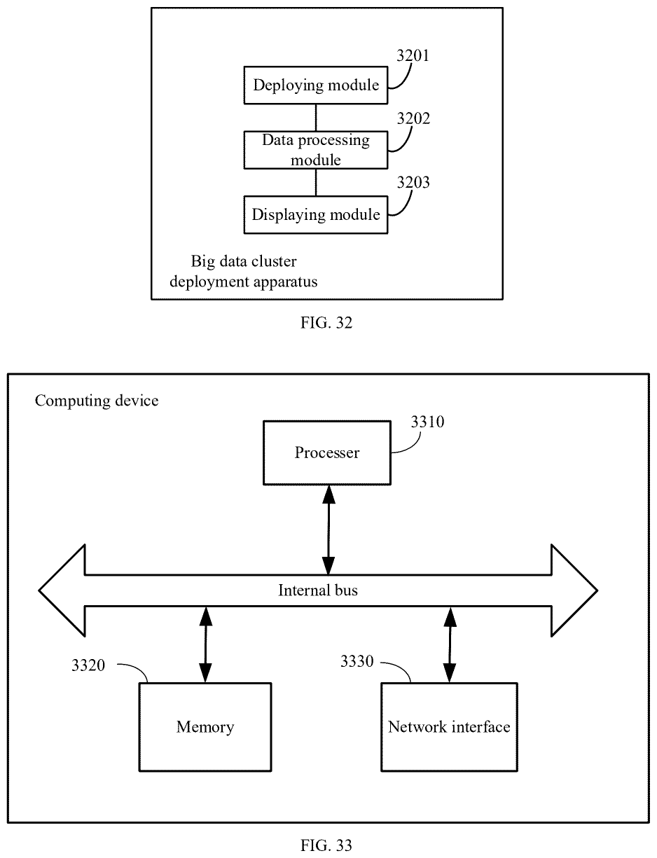

Referring to FIG. 32, FIG. 32 is a block diagram of an apparatus for deploying a big data cluster according to embodiments of the present disclosure. As shown in FIG. 32, the apparatus includes:
a deploying module 3201, configured to deploy a data collecting service, a monitoring and alerting service, and a data visualizing and analyzing service for the big data cluster;
a data processing module 3202, configured to collect, by the data collecting service, operational data of the big data cluster, and upload, by the monitoring and alerting service, the operational data to the data visualizing and analyzing service; and
a displaying module 3203, configured to display, by the data visualizing and analyzing service, a monitoring interface according to the operational data, where the monitoring interface is configured to display operational status of the big data cluster in a graphical manner.

In some embodiments of the present disclosure, the deploying module 3201 when configured to deploy a data collecting service, a monitoring and alerting service, and a data visualizing and analyzing service for the big data cluster, is configured to:
according to a deployed service provider in the big data cluster, deploy the data collecting service, the monitoring and alerting service, and the data visualizing and analyzing service for the deployed service provider in the big data cluster; and
in response to an update operation on the deployed service provider in the big data cluster, update a deployed data collecting service, a deployed monitoring and alerting service, and a deployed data visualizing and analyzing service in the big data cluster, where the update operation on the deployed service provider includes deleting the deployed service provider and deploying a new service provider.

In some embodiments of the present disclosure, a service provider includes a server and/or a container, the big data cluster includes servers, and the servers include a management server;

The deploying module 3201, when configured to, according to a deployed service provider in the big data cluster, deploy the data collecting service, the monitoring and alerting service, and the data visualizing and analyzing service for the deployed service provider in the big data cluster, is configured to:
according to servers and containers in the big data cluster, deploy the data collecting service on each of the servers of the big data cluster, and deploy the monitoring and alerting service and the data visualizing and analyzing service on the management server of the big data cluster.

In some embodiments of the present disclosure, the data collecting service includes a first data collecting service and a second data collecting service, where the first data collecting service is used to collect operational data of a server, and the second data collecting service is used to collect operational data of a container;
the deploying module 3201, when configured to, according to the servers and the containers in the big data cluster, deploy the data collecting service on each of the servers of the big data cluster, is configured to:
deploy the first data collecting service and the second data collecting service on the management server, and deploy the first data collecting service on each of the servers except the management server.

In some embodiments of the present disclosure, the service provider includes a server and/or a container, and the monitoring and alerting service corresponds to a first configuration file
in a case where the update operation on the deployed service provider includes deploying a new service provider, the deploying module 3201, when in response to the update operation on the deployed service provider in the big data cluster, updating a deployed data collecting service, a deployed monitoring and alerting service, and a deployed data visualizing and analyzing service in the big data cluster, is configured to at least one of:
in response to addition of a new server in the big data cluster, deploy the first data collecting service on the new server, and modify the first configuration file corresponding to the monitoring and alerting service according to a new service provider, to enable the deployed monitoring and alerting service and the deployed data visualizing and analyzing service in the big data cluster to provide services for the new server; or
in response to addition of a new container in the big data cluster, modify the first configuration file corresponding to the monitoring and alerting service according to a new server, to enable the deployed second data collecting service, the deployed monitoring and alerting service, and the deployed data visualizing and analyzing service in the big data cluster to provide services for the new container.

In some embodiments of the present disclosure, in a case where the update operation on the deployed service provider includes deleting a deployed service provider, the deploying module 3201, when in response to the update operation on the deployed service provider in the big data cluster, updating a deployed data collecting service, a deployed monitoring and alerting service, and a deployed data visualizing and analyzing service in the big data cluster, is configured to at least one of:
in response to deletion of a deployed server in the big data cluster, delete the first data collecting service corresponding to a deleted server, and modify the first configuration file corresponding to the monitoring and alerting service according to the deleted server, to enable the deployed monitoring and alerting service and the deployed data visualizing and analyzing service in the big data cluster no longer to provide services for the deleted server; or
in response to deletion of a deployed container in the big data cluster, modify the first configuration file corresponding to the monitoring and alerting service according to a deleted server, to enable the deployed second data collecting service, the deployed monitoring and alerting service, and the deployed data visualizing and analyzing service in the big data cluster no longer to provide services for the deleted server.

In some embodiments of the present disclosure, the data collecting service, the monitoring and alerting service, and the data visualizing and analyzing service are located in the Overlay network, the data collecting service includes an Exporter service, the monitoring and alerting service includes a Prometheus service, and the data visualizing and analyzing service includes a Grafana service.

In some embodiments of the present disclosure, the first data collecting service includes a Node Exporter service; in a case where the container corresponds to an HDFS component or a YARN component, the second data collecting service includes a Hadoop Exporter service; in a case where the container corresponds to a Clickhouse component, the second data collecting service includes a Clickhouse Exporter service.

In some embodiments of the present disclosure, the service provider includes a server and/or a container; for servers in the big data cluster, the operational data includes disk space usage data, network traffic data, CPU usage data, memory usage data, or any combination thereof; and for containers in the big data cluster, the operational data includes big data service usage data, container status data, or a combination thereof.

In some embodiments of the present disclosure, the service provider includes a server and/or a container;

The displaying module 3203, when displaying the monitoring interface according to the operational data, is configured to at least one of:
according to the operational data of servers in the big data cluster, display a physical-layer monitoring interface, where the physical-layer monitoring interface is configured to display the operational data of the servers in the big data cluster; or
according to the operational data of containers in the big data cluster, display a component-layer monitoring interface, where the component-layer monitoring interface is configured to display the operational data of the containers in the big data cluster.

In some embodiments of the present disclosure, the apparatus further includes:
a transmitting module, configured to, in response to an anomaly in the operational data collected by the data collecting service, transmit alerting information by the monitoring and alerting service.

In some embodiments of the present disclosure, the big data cluster includes servers, and the servers include a management server;

The displaying module 3203 is further configured to display a deployment interface, and display a management node corresponding to the management server in the deployment interface; and
the apparatus further includes:
a copying module, configured to, in response to a drag and drop operation on the management node in deployment interface, copy configuration data of the management server to a destination server indicated by the drag and drop operation.

In some embodiments of the present disclosure, a virtual IP address is pre-set for the management server;
a second deleting module is configured to delete the virtual IP address preset for the management server and configure the virtual IP address to the destination server; and
the second deleting module is further configured to delete configuration data in the management server.

In some embodiments of the present disclosure, a startup module is configured to initiate services corresponding to the configuration data in the destination server according to the configuration data copied from the management server; and
the second deleting module is further configured to, in response to determining that each of the services in the destination server is initiated normally, delete the virtual IP address preset for the management server and configure the virtual IP address to the destination server.

In some embodiments of the present disclosure, the displaying module 3203 is further configured to, in response to the drag and drop operation on the management node in the deployment interface, display the prompt information, where the prompt information is configured to prompt that the management server and the destination server are being redeployed.

In some embodiments of the present disclosure, the second deleting module is further configured to, according to an instruction of the drag and drop operation on the management node in the deployment interface, delete the management node corresponding to the management server from the deployment interface.

The displaying module 3203 is further configured to display the management node corresponding to the destination server in the deployment interface.

In some embodiments of the present disclosure, the deploying module 3201 is further configured to deploy a gateway proxy service for the big data cluster, where the gateway proxy service is configured to provide an access function for a user outside the big data cluster.

In some embodiments of the present disclosure, the big data cluster includes servers, and the servers include a management server;

The deploying module 3201, when deploying a gateway proxy service for the big data cluster, is configured to:
deploy the gateway proxy service on the management server; and
in response to addition of a new service provider in the big data cluster, deploy the gateway proxy service for the new service provider.

In some embodiments of the present disclosure, the display module 3203 is further configured to display a deployment interface and displaying an information viewing control in the deployment interface, where the information viewing control is configured to provide a viewing function for a network address of a container; and
the displaying module 3203 is further configured to, in response to a triggering operation of the information viewing control, display the network address of the container displayed in the deployment interface.

In some embodiments of the present disclosure, the deployment interface includes a deployment resource pool region, where the deployment resource pool region is configured to display a node corresponding to a deployed container on a server of the big data cluster; and
the displaying module 3203, when displaying the information viewing control in the deployment interface, is configured to:
display the information viewing control in the deployment resource pool region of the deployment interface; and
the displaying module 3203, when in response to a triggering operation of the information viewing control, displaying the network address of the container displayed in the deployment interface, is configured to:
in response to the triggering operation of the information viewing control, display the network address of the container displayed in the deployment resource pool region.

In some embodiments of the present disclosure, a service provider deployed in the big data cluster is deployed according to a drag and drop operation on a node in the deployment interface.

Since the apparatus embodiments basically corresponds to the method embodiments, the relevant parts can refer to the partial description of the method embodiments. The device examples described above are merely illustrative, where the modules described as separate members may be or not be physically separated, and the members displayed as modules may be or not be physical units, i.e., may be located in one place, or may be distributed in a plurality of network modules. Some or all of the modules can be selected according to the actual needs to achieve the purpose of the technical solutions of the present disclosure. A person skilled in the art can understand and implement without creative work.

In the present disclosure, a computing device is further provided, as shown in FIG. 33, FIG. 33 is a schematic structural diagram of a computing device according to embodiments of the present disclosure. As shown in FIG. 33, the computing device includes a processor 3310, a memory 3320, and a network interface 3330. The memory 3320 is configured to store computer instructions that can be run on the processor 3310, the processor 3310 is configured to, when executing the computer instructions, implement the method for deploying big data cluster provided by any embodiment of the present disclosure. The network interface 3330 is configured to implement input and output functions. In some embodiments, the computing device may further include other hardware, which is not limited in the present disclosure.

In the present disclosure, a computer-readable storage medium is further provided, which can be in various forms. For example, in different examples, the computer-readable storage medium can be a Random Access Memory (RAM), a volatile memory, a non-volatile memory, a flash memory, a storage drive (e.g. hard disk drive), a solid state hard disk, any type of storage disk (e.g., compact disk, Digital Video Disk (DVD)), or a similar storage medium, or a combination thereof. In some embodiments, the computer-readable storage medium can further be a paper or other suitable media that can print programs. A computer program is stored on the computer-readable storage medium, and the computer program when executed by a processor achieves the method for deploying big data cluster provided in any embodiment of the present disclosure.

The present disclosure also provides a computer program product, including a computer program that implements the deployment method of a big data cluster provided in any embodiment of the present disclosure when the computer program is executed by a processor.

As will be understood by the skilled in the art, one or more embodiments of this specification may be provided as methods, devices, computing devices, computer-readable storage media, or computer program products. Accordingly, one or more embodiments of this specification may take the form of an entirely hardware embodiment, an entirely software embodiment, or an embodiment combining software and hardware aspects. Furthermore, one or more embodiments of the present specification may employ the form of a computer program product implemented on one or more computer-usable storage media (including, but not limited to, disk storage, CD-ROM, optical storage, etc.), where the one or more computer-usable storage media having computer-usable program codes.

The various embodiments in the present disclosure are described in a progressive manner, and the same or similar parts between the various embodiments may be referred to each other, and each embodiment focuses on the differences from other embodiments. In particular, for a computing device embodiment, since it is basically similar to the method embodiment, the description is relatively simple, and for related parts, please refer to the partial description of the method embodiment.

The foregoing describes specific embodiments of the present specification. Other embodiments are within the scope of the present disclosure. In some cases, the acts or steps recited in the present disclosure can be performed in an order different from that in the embodiments and still achieve desirable results. Additionally, the processes depicted in the fugures do not necessarily require the shown particular order or sequential order, to achieve desirable results. In some embodiments, multitasking and parallel processing are also possible or may be advantageous.

Embodiments of the subject matter and functional operations described in this specification can be implemented in digital electronic circuitry, tangible computer software or firmware, computer hardware including the structures disclosed in this specification and their structural equivalents, or a combination of one or more thereof. Embodiments of the subject matter described in this specification may be implemented as one or more computer programs, i.e., one or more of modules in computer program instructions encoded on a tangible, non-transitory program carrier to be executed by an apparatus for deploying the big data cluster, or to control the operation for deploying the big data cluster. Alternatively or additionally, the program instructions may be encoded on an artificially generated propagating signal, such as a machine-generated electrical, optical or electromagnetic signal, which is generated to encode and transmit information to a suitable receiver device to be executed by the apparatus for deploying the big data cluster. The computer storage medium may be a machine-readable storage device, a machine-readable storage substrate, a random or serial access memory device, or a combination of one or more thereof.

The processes and logic flows described in this specification can be performed by one or more programmable computers executing one or more computer programs to perform corresponding functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, for example, general and/or special purpose microprocessors, or any other type of central processing unit. Typically, the central processing unit will receive instructions and data from read only memory and/or random-access memory. The basic components of a computer include a central processing unit for implementing or executing instructions and one or more memory devices for storing instructions and data. Typically, a computer also includes one or more high-capacity storage devices for storing data, such as magnetic, magneto-optical or optical disks, or a computer is operably coupled to the high-capacity storage devices to receive data therefrom or transfer data thereto, or both. However, the computer does not have to have such a device. Furthermore, the computer may be embedded in another device such as a mobile phone, personal digital assistant (PDA), mobile audio or video player, game console, global positioning system (GPS) receiver, or a portable storage device (such as a universal serial bus (USB) flash drive), only a few examples are named here.

Computer readable media suitable for storage of computer program instructions and data include all forms of non-volatile memory, media, and memory devices, including, for example, semiconductor memory devices (e.g., EPROM, EEPROM, and flash memory devices), magnetic disks (e.g., internal hard disks or removable discs), magneto-optical discs, and CD-ROM and DVD-ROM discs. The processor and memory may be supplemented by or incorporated in special purpose logic circuitry.

While this specification contains many specific implementation details, these should not be understood as limiting the scope of any invention or what may be claimed, but are used primarily to describe features of specific embodiments of particular inventions. Certain features that are described in this specification in multiple embodiments can also be implemented in combination in a single embodiment. On the other hand, various features that are described in the context of a single embodiment can also be implemented in multiple embodiments separately or in any suitable subcombination. Furthermore, although features may function as described above in certain combinations and even be originally claimed as such, one or more features from a claimed combination may in some cases be removed from the combination and the claimed protected combination may point to a subcombination or a variation of a subcombination.

Similarly, although operations in the figures are depicted in a particular order, this should not be construed as requiring that the operations be performed in the particular order shown or sequentially, or that all illustrated operations be performed, to achieve the desired result. In some cases, multitasking and parallel processing may be advantageous. Furthermore, the separation of the various system modules and components in the above-described embodiments should not be construed as requiring such separation in all embodiments, and it should be understood that the described program components and systems may generally be integrated together in a single software product, or packaged into multiple software products.

Thus, specific embodiments of the subject matter have been described. Other embodiments are within the scope of the present disclosure. In some cases, the actions recited in the present disclosure can be performed in a different order and still achieve desirable results. Furthermore, the processes depicted in the figures do not necessarily require the particular order shown, or sequential order, to achieve desirable results. In some implementations, multitasking and parallel processing may be advantageous.

Other implementations of the present disclosure will be apparent to those skilled in the art from consideration of the specification and practice of the present disclosure herein. The present disclosure is intended to cover any modification, use or adaptation of the present disclosure. These modifications, uses or adaptations follow the general principles of the present disclosure and include common knowledge and conventional technical means in the technical field that are not disclosed in the present disclosure. It is to be understood that the present disclosure is not limited to the precise structures described above and shown in the accompanying drawings and can be modified or changed without departing from the scope of the present disclosure.

The above is only a preferred embodiment of the present disclosure and is not intended to limit the present disclosure. Any modifications, equivalent replacements, improvements, etc. made within the spirit and principles of the present disclosure shall be included in the scope of protection of the present disclosure.

1. A method comprising:
deploying a data collecting service, a monitoring and alerting service, and a data visualizing and analyzing service for a server cluster;
collecting, by the data collecting service, operational data of the server cluster, and uploading, by the monitoring and alerting service, the operational data to the data visualizing and analyzing service; and
displaying, by the data visualizing and analyzing service, a monitoring interface according to the operational data, wherein the monitoring interface is configured to display operational status of the server cluster in a graphical manner.

2. The method according to claim 1, wherein deploying the data collecting service, the monitoring and alerting service, and the data visualizing and analyzing service comprises:
according to a deployed service provider in the server cluster, deploying the data collecting service, the monitoring and alerting service, and the data visualizing and analyzing service for the deployed service provider; and
in response to an update operation on the deployed service provider, updating the data collecting service, the monitoring and alerting service, and the data visualizing and analyzing service, wherein the update operation comprises deleting the deployed service provider and deploying a new service provider.

3. The method according to claim 2, wherein the deployed service provider comprises a server and/or a container, the server cluster comprises servers, and the servers comprise a management server;
deploying the data collecting service, the monitoring and alerting service, and the data visualizing and analyzing service comprises:
according to servers and containers in the server cluster, deploying the data collecting service on each of the servers, and deploying the monitoring and alerting service and the data visualizing and analyzing service on the management server.

4. The method according to claim 3, wherein the data collecting service comprises a first data collecting service and a second data collecting service, wherein the first data collecting service is configured to collect operational data of one of the servers, and the second data collecting service is configured to collect operational data of one of the containers;
deploying the data collecting service on each of the servers comprises:
deploying the first data collecting service and the second data collecting service on the management server, and deploying the first data collecting service on each of the servers except the management server.

5. The method according to claim 4, wherein the deployed service provider comprises a server and/or a container, and the monitoring and alerting service is provided with a first configuration file;
wherein the update operation on the deployed service provider comprises deploying the new service provider, updating the data collecting service, the monitoring and alerting service, and the data visualizing and analyzing service comprises:
in response to addition of a new server in the server cluster, deploying the first data collecting service on the new server, and modifying the first configuration file according to a new service provider, to enable the deployed monitoring and alerting service and the deployed data visualizing and analyzing service in the server cluster to provide services for the new server; or
in response to addition of a new container in the server cluster, modifying the first configuration file according to the new container, to enable the second data collecting service, the deployed monitoring and alerting service, and the deployed data visualizing and analyzing service in the server cluster to provide services for the new container; or
both.

6. The method according to claim 5, wherein the update operation on the deployed service provider comprises deleting the deployed service provider, wherein in response to the update operation on the deployed service provider, updating the data collecting service, the monitoring and alerting service, and the data visualizing and analyzing service comprises:
in response to deletion of a deployed server in the server cluster, deleting the first data collecting service corresponding to the deployed server, and modifying the first configuration file according to the deleted server, to enable the deployed monitoring and alerting service and the deployed data visualizing and analyzing service in the server cluster no longer to provide services for the deleted server; or
in response to deletion of a deployed container in the server cluster, modifying the first configuration file according to the deployed container, to enable the second data collecting service, the deployed monitoring and alerting service, and the deployed data visualizing and analyzing service in the server cluster no longer to provide services for the deleted container; or
both.

7-8. (canceled)

9. The method according to claim 2, wherein the deployed service provider comprises a server and/or a container; wherein the operational data comprises disk space usage data, network traffic data, CPU usage data, memory usage data, or any combination thereof or the operational data comprises service usage data, container status data, or a combination thereof.

10. The method according to claim 1, wherein the server cluster comprises a plurality of service providers, wherein the plurality of service providers comprise servers and/or containers; displaying the monitoring interface according to the operational data comprises:
according to the operational data, displaying a physical-layer monitoring interface, wherein the physical-layer monitoring interface is configured to display the operational data; or
according to the operational data, displaying a component-layer monitoring interface, wherein the component-layer monitoring interface is configured to display the operational data; or
both.

11. The method according to claim 1, further comprising:
in response to an anomaly in the operational data, transmitting alerting information by the monitoring and alerting service.

12. The method according to claim 1, wherein the server cluster comprises servers, and the servers comprise a management server;
wherein the method further comprises:
displaying a deployment interface, and displaying a management node corresponding to the management server in the deployment interface; and
wherein the method further comprises:
in response to a drag and drop operation on the management node in the deployment interface, copying configuration data of the management server to a destination server indicated by the drag and drop operation.

13. The method according to claim 12, wherein a virtual IP address is preset for the management server;
wherein after copying the configuration data, the method further comprises:
deleting the virtual IP address preset for the management server and configuring the virtual IP address to the destination server; and
deleting the configuration data in the management server.

14. The method according to claim 13, wherein before deleting the virtual IP address preset for the management server and configuring the virtual IP address to the destination server, the method further comprises:
initiating services corresponding to the configuration data in the destination server according to the configuration data; and
in response to determining that each of the services in the destination server is initiated normally, deleting the virtual IP address preset for the management server and configuring the virtual IP address to the destination server.

15. The method according to claim 13, further comprising:
in response to the drag and drop operation, displaying prompt information, wherein the prompt information is configured to prompt that the management server and the destination server are being redeployed;
wherein after deleting the configuration data in the management server, the method further comprises:
according to an instruction of the drag and drop operation, deleting the management node corresponding to the management server from the deployment interface, and displaying the management node corresponding to the destination server in the deployment interface.

16. (canceled)

17. The method according to claim 1, further comprising:
deploying a gateway proxy service for the server cluster, wherein the gateway proxy service is configured to provide an access function for a user outside the server cluster.

18. The method according to claim 17, wherein the server cluster comprises servers, and the servers comprise a management server;
wherein deploying the gateway proxy service comprises:
deploying the gateway proxy service on the management server; and
in response to addition of a new service provider in the server cluster, deploying the gateway proxy service for the new service provider.

19. The method according to claim 17, further comprising:
displaying a deployment interface and displaying an information viewing control in the deployment interface, wherein the information viewing control is configured to provide a viewing function for a network address of a container; and
in response to a triggering operation of the information viewing control, displaying the network address of the container displayed in the deployment interface;
wherein the deployment interface comprises a deployment resource pool region, wherein the deployment resource pool region is configured to display a node corresponding to a deployed container on a server of the server cluster; and
wherein displaying the information viewing control in the deployment interface comprises:
displaying the information viewing control in the deployment resource pool region of the deployment interface; and
wherein in response to the triggering operation of the information viewing control, displaying the network address of the container displayed in the deployment interface comprises:
in response to the triggering operation of the information viewing control, displaying the network address of the container displayed in the deployment resource pool region.

20. (canceled)

21. The method according to claim 1, wherein a service provider deployed in the server cluster is deployed according to a drag and drop operation on a node in a deployment interface.

22. (canceled)

23. A computer device comprising a non-transitory memory, a processor and a computer program stored on the non-transitory memory and runnable on the processor, wherein the processor, when executing the program, performs the method according to claim 1.

24. A non-transitory computer-readable storage medium, wherein the non-transitory storage medium stores a program, and the program when executed by a processor performs the method according to claim 1.
